(19) United States
(12) Patent Application Publication
(10) Pub. No.: US 2026/0019631 A1
(43) Pub. Date: Jan. 15, 2026

(54) METHOD AND APPARATUS FOR INTRA PREDICTION MODE

(71) Applicant: Tencent America LLC, Palo Alto, CA (US)

(72) Inventors: Biao WANG, San Jose, CA (US); Stephan WENGER, Hillsborough, CA (US); Roman CHERNYAK, Santa Clara, CA (US); Yonguk YOON, Palo Alto, PA (US); Lien-fei CHEN, Palo Alto, CA (US); Motong XU, Palo Alto, CA (US); Ziyue XIANG, Palo Alto, CA (US); Shan LIU, San Jose, CA (US); Yifan WANG, Palo Alto, CA (US)

(73) Assignee: Tencent America LLC, Palo Alto, CA (US)

(21) Appl. No.: 19/266,130

(22) Filed: Jul. 10, 2025

Related U.S. Application Data
(60) Provisional application No. 63/671,180, filed on Jul. 13, 2024.
(60) Provisional application No. 63/671,265, filed on Jul. 14, 2024.
(60) Provisional application No. 63/672,208, filed on Jul. 16, 2024.
(60) Provisional application No. 63/709,441, filed on Oct. 19, 2024.
(60) Provisional application No. 63/716,717, filed on Nov. 5, 2024.
(60) Provisional application No. 63/717,865, filed on Nov. 7, 2024.

(51) Int. Cl. H04N 19/593; H04N 19/176; H04N 19/82

(52) U.S. Cl. CPC H04N 19/593; H04N 19/176; H04N 19/82

(57) ABSTRACT

A current block is coded based on an extrapolation filter-based intra prediction according to one of a plurality of candidate models. Each of the plurality of candidate models is associated with a respective filter and includes a plurality of filter coefficients of the respective filter. A reference value is determined based on neighboring samples in a template region of the current block. The one of the plurality of candidate models to predict the current block is determined based on a comparison between the reference value and a threshold value. A clipping range of prediction sample values of the current block is determined. The prediction sample values of the current block are obtained based on the one of the plurality of candidate models. The current block is reconstructed based on a portion of the prediction sample values in the clipping range.

### INCORPORATION BY REFERENCE

The present application claims the benefit of priority to U.S. Provisional Application No. 63/671,180, “MULTI-MODEL EXTRAPOLATION FILTER-BASED INTRA PREDICTION WITH CLIPPING” filed on Jul. 13, 2024, U.S. Provisional Application No. 63/671,265, “MULTI-HYPOTHESIS INTRA PREDICTION” filed on Jul. 14, 2024, U.S. Provisional Application No. 63/672,208, “DIRECTIONAL PADDING ON PICTURE BOUNDARY PADDING” filed on Jul. 16, 2024, U.S. Provisional Application No. 63/709,441, “REFERENCE SAMPLE SHIFTING FOR INTRA PREDICTION” filed on Oct. 19, 2024, U.S. Provisional Application No. 63/716,717, “INTRA MODE DERIVATION WITH SIGNALED SYNTAX AND MOST PROBABLE MODE ADAPTATION” filed on Nov. 5, 2024, and U.S. Provisional Application No. 63/717,865, “HISTOGRAM OF GRADIENTS-BASED DIRECTIONAL PLANAR” filed on Nov. 7, 2024. The entire disclosures of the prior applications are hereby incorporated by reference in their entirety.

### TECHNICAL FIELD

The present disclosure describes aspects generally related to video coding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Image/video compression can help transmit image/video data across different devices, storage and networks with minimal quality degradation. In some examples, video codec technology can compress video based on spatial and temporal redundancy. In an example, a video codec can use techniques referred to as intra prediction that can compress an image based on spatial redundancy. For example, the intra prediction can use reference data from the current picture under reconstruction for sample prediction. In another example, a video codec can use techniques referred to as inter prediction that can compress an image based on temporal redundancy. For example, the inter prediction can predict samples in a current picture from a previously reconstructed picture with motion compensation. The motion compensation can be indicated by a motion vector (MV).

### SUMMARY

Aspects of the disclosure include bitstreams, methods, and apparatuses for video encoding/decoding. In some examples, an apparatus for video encoding/decoding includes processing circuitry.

According to an aspect of the disclosure, a method of video decoding is provided. In the method, a video bitstream including coded information of a current block in a current picture is received. The coded information indicates that the current block is coded based on an extrapolation filter-based intra prediction according to one of a plurality of candidate models. Each of the plurality of candidate models is associated with a respective filter and includes a plurality of filter coefficients of the respective filter. A reference value is determined based on neighboring samples in a template region of the current block. The one of the plurality of candidate models to predict the current block is determined based on a comparison between the reference value and a threshold value. A clipping range of prediction sample values of the current block is determined. The prediction sample values of the current block are obtained based on the one of the plurality of candidate models. The current block is reconstructed based on a portion of the prediction sample values in the clipping range.

According to another aspect of the disclosure, a method of video decoding is provided. In the method, a video bitstream including coded information of a current picture and a reference picture of the current picture is received. Whether directional padding is applied to a padding area is determined. The padding area is outside and adjacent to a boundary of the current picture. A padding direction of the directional padding is determined based on a direction of an intra prediction mode derived from one of a boundary block in the current picture and a motion compensation (MC) block in the padding area. The boundary block is within and adjacent to the boundary of the current picture. A portion of the padding area is padded based on a plurality of samples in the current picture along the padding direction.

According to yet another aspect of the disclosure, a method of video decoding is provided. In the method, a video bitstream including coded information of a current block in a current picture is received. The coded information indicates a prediction mode of the current block that is associated with a list of most probable modes (MPMs) that is generated based on first type of prediction information and a list of most dominant modes (MDMs) that is generated based on a second type of prediction information. The list of MDMs that includes a plurality of candidate MDMs is determined based on a reference region of the current block. The current block is reconstructed based on at least one of (i) a candidate MDM in the plurality of candidate MDMs in the list of MDMs and (ii) a candidate MPM in the list of MPMs.

Aspects of the disclosure include a method of video encoding. In the method, a reference value is determined based on neighboring samples in a template region of a current block in a current picture. The current block is coded based on an extrapolation filter-based intra prediction according to one of a plurality of candidate models. Each of the plurality of candidate models is associated with a respective filter and includes a plurality of filter coefficients of the respective filter. The one of the plurality of candidate models to predict the current block is determined based on a comparison between the reference value and a threshold value. A clipping range of prediction sample values of the current block is determined. The prediction sample values of the current block are obtained based on the one of the plurality of candidate models. The current block is encoded based on a portion of the prediction sample values in the clipping range.

Aspects of the disclosure include a method of video encoding. In the method, whether directional padding is applied to a padding area is determined. The padding area is outside and adjacent to a boundary of a current picture. A padding direction of the directional padding is determined based on a direction of an intra prediction mode derived from one of a boundary block within and adjacent to the boundary of the current picture and a MC block in the padding area. A portion of the padding area is encoded by padding the portion of the padding area based on a plurality of samples in the current picture along the padding direction.

Aspects of the disclosure include a method of video encoding. In the method, a list of MPMs for a current block in a current picture is determined. A list of MDMs for the current block is determined. The list of MDMs includes a plurality of candidate MDMs based on a reference region of the current block. The current block is encoded into a bitstream based on at least one of (i) a candidate MDM in the plurality of candidate MDMs in the list of MDMs and (ii) a candidate MPM in the list of MPMs.

Aspects of the disclosure include a non-transitory computer-readable medium storing a video media bitstream encoded by an encoding method. In the encoding method, a reference value is determined based on neighboring samples in a template region of a current block in a current picture. The current block is coded based on an extrapolation filter-based intra prediction according to one of a plurality of candidate models. Each of the plurality of candidate models is associated with a respective filter and includes a plurality of filter coefficients of the respective filter. The one of the plurality of candidate models to predict the current block is determined based on a comparison between the reference value and a threshold value. A clipping range of prediction sample values of the current block is determined. The prediction sample values of the current block are obtained based on the one of the plurality of candidate models. The current block is encoded based on a portion of the prediction sample values in the clipping range.

Aspects of the disclosure include a non-transitory computer-readable medium storing a video media bitstream encoded by an encoding method. In the encoding method, whether directional padding is applied to a padding area is determined. The padding area is outside and adjacent to a boundary of a current picture. A padding direction of the directional padding is determined based on a direction of an intra prediction mode derived from one of a boundary block within and adjacent to the boundary of the current picture and a MC block in the padding area. A portion of the padding area is encoded by padding the portion of the padding area based on a plurality of samples in the current picture along the padding direction.

Aspects of the disclosure include a non-transitory computer-readable medium storing a video media bitstream encoded by an encoding method. In the encoding method, a list of MPMs for a current block in a current picture is determined. A list of MDMs for the current block is determined. The list of MDMs includes a plurality of candidate MDMs based on a reference region of the current block. The current block is encoded into a bitstream based on at least one of (i) a candidate MDM in the plurality of candidate MDMs in the list of MDMs and (ii) a candidate MPM in the list of MPMs.

Aspects of the disclosure include a method of processing visual media data. The method includes processing a bitstream of the visual media data according to a format rule. The bitstream includes coded information of a current block in a current picture. The coded information indicates that the current block is coded based on an extrapolation filter-based intra prediction according to one of a plurality of candidate models. Each of the plurality of candidate models is associated with a respective filter and includes a plurality of filter coefficients of the respective filter. The format rule specifies that a reference value is determined based on neighboring samples in a template region of the current block. The format rule specifies that the one of the plurality of candidate models to predict the current block is determined based on a comparison between the reference value and a threshold value. The format rule specifies that a clipping range of prediction sample values of the current block is determined. The prediction sample values of the current block are obtained based on the one of the plurality of candidate models. The format rule specifies that the current block is processed based on a portion of the prediction sample values in the clipping range.

Aspects of the disclosure include a method of processing visual media data. The method includes processing a bitstream of the visual media data according to a format rule. The bitstream includes coded information of a current picture and a reference picture of the current picture. The format rule specifies that whether directional padding is applied to a padding area that is outside and adjacent to a boundary of the current picture is determined. The format rule specifies that a padding direction of the directional padding is determined based on a direction of an intra prediction mode derived from one of a boundary block within and adjacent to the boundary of the current picture and a MC block in the padding area. The format rule specifies that a portion of the padding area is padded based on a plurality of samples in the current picture along the padding direction.

Aspects of the disclosure include a method of processing visual media data. The method including processing a bitstream of the visual media data according to a format rule. The bitstream includes coded information of a current block in a current picture. The coded information indicates a prediction mode of the current block that is associated with a list of MPMs that is generated based on first type of prediction information and a list of MDMs that is generated based on a second type of prediction information. The format rule specifies that the list of MDMs that includes a plurality of candidate MDMs is determined based on a reference region of the current block. The format rule specifies that the current block is processed based on at least one of (i) a candidate MDM in the plurality of candidate MDMs in the list of MDMs and (ii) a candidate MPM in the list of MPMs.

Aspects of the disclosure also provide an apparatus for video decoding. The apparatus for video decoding including processing circuitry configured to implement any of the described methods for video decoding.

Aspects of the disclosure also provide an apparatus for video encoding. The apparatus for video encoding including processing circuitry configured to implement any of the described methods for video encoding.

Aspects of the disclosure also provide a non-transitory computer-readable storage medium storing instructions which, when executed by at least one processor, cause the at least one processor to perform any of the described methods.

Aspects of the disclosure also provide a non-transitory computer-readable storage medium storing a video media bitstream which when processed by at least one processor cause the at least one processor to perform any of the described methods for video decoding.

Technical solutions of the disclosure include methods and apparatuses to improve intra prediction coding. The methods include (i) a multi-model extrapolation filter-based intra prediction, (ii) an intra prediction by using multiple hypothesis models, (iii) a directional padding for picture boundary padding, (iv) a reference shifting for intra prediction, (v) an intra mode derivation with signaled syntax and most probable mode adaption, and (vi) a histogram of gradients-based directional planar.

In an example, a video bitstream including coded information of a current block in a current picture is received. The coded information indicates that the current block is coded based on an extrapolation filter-based intra prediction according to one of a plurality of candidate models. Each of the plurality of candidate models is associated with a respective filter and includes a plurality of filter coefficients of the respective filter. A reference value is determined based on neighboring samples in a template region of the current block. The one of the plurality of candidate models to predict the current block is determined based on a comparison between the reference value and a threshold value. A clipping range of prediction sample values of the current block is determined. The prediction sample values of the current block are obtained based on the one of the plurality of candidate models. The current block is reconstructed based on a portion of the prediction sample values in the clipping range.

In an example, a video bitstream including coded information of a current picture and a reference picture of the current picture is received. Whether directional padding is applied to a padding area is determined. The padding area is outside and adjacent to a boundary of the current picture. A padding direction of the directional padding is determined based on a direction of an intra prediction mode derived from one of a boundary block in the current picture and a motion compensation (MC) block in the padding area. The boundary block is within and adjacent to the boundary of the current picture. A portion of the padding area is padded based on a plurality of samples in the current picture along the padding direction.

In an example, a video bitstream including coded information of a current block in a current picture is received. The coded information indicates a prediction mode of the current block that is associated with a list of most probable modes (MPMs) that is generated based on first type of prediction information and a list of most dominant modes (MDMs) that is generated based on a second type of prediction information. The list of MDMs that includes a plurality of candidate MDMs is determined based on a reference region of the current block. The current block is reconstructed based on at least one of (i) a candidate MDM in the plurality of candidate MDMs in the list of MDMs and (ii) a candidate MPM in the list of MPMs.

Thus, coding efficiencies and accuracies of the intra prediction are improved based on one or more of the various methods that include (i) the multi-model extrapolation filter-based intra prediction, (ii) the intra prediction by using multiple hypothesis models, (iii) the directional padding for picture boundary padding, (iv) the reference shifting for intra prediction, (v) the intra mode derivation with signaled syntax and most probable mode adaption, and (vi) the histogram of gradients-based directional planar.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an example of a block diagram of a communication system (100).

FIG. 2 is a schematic illustration of an example of a block diagram of a decoder.

FIG. 3 is a schematic illustration of an example of a block diagram of an encoder.

FIG. 4 shows various examples of extrapolation filter shapes according to some aspects of the disclosure.

FIG. 5 shows various examples of template types according to some aspects of the disclosure.

FIG. 6 shows an example of prediction generation for different positions in a current block by a diagonal order.

FIG. 7 shows an example of threshold value calculation based on an average value in a reconstructed area.

FIG. 8 shows various examples of reference value calculations.

FIG. 9 shows an example of derivation of a clipping range in a reconstructed area.

FIG. 10 shows a flow chart outlining a decoding process of multi-hypothesis intra prediction indicated by a flag.

FIG. 11 shows a flow chart outlining a decoding process of multi-hypothesis intra prediction determined by a multi-hypothesis data size.

FIG. 12 shows a flow chart outlining a decoding process of multi-hypothesis intra prediction including an implicit intra prediction mode assignment.

FIG. 13 shows an example of repetitive padding and motion compensated (MC) boundary padding.

FIG. 14 shows an example of derivation of a padding block.

FIG. 15 shows an example of repetitive padding according to some aspects of the disclosure.

FIG. 16 shows an example of directional padding according to some aspects of the disclosure.

FIG. 17 shows an example of vertical intra prediction according to some aspects of the disclosure.

FIG. 18 shows an example of reference sample shifting according to some aspects of the disclosure.

FIG. 19 shows various examples of reference sample shifting according to some aspects of the disclosure.

FIG. 20 shows an example of a decoder-side gradient based intra mode derivation.

FIG. 21 shows an example of derivation of an inter prediction mode using reconstructed samples in a template.

FIG. 22 shows an example of a termination condition for histogram construction based on a threshold value.

FIG. 23 shows an example of reference samples when a top template is considered.

FIG. 24 shows an example of reference samples when a left template is considered.

FIG. 25 shows an example of a histogram construction based on block vector guided templates.

FIG. 26 shows a flow chart outlining a decoding process according to some aspects of the disclosure.

FIG. 27 shows a flow chart outlining a decoding process according to some aspects of the disclosure.

FIG. 28 shows a flow chart outlining a decoding process according to some aspects of the disclosure.

FIG. 29 is a schematic illustration of a computer system in accordance with an aspect.

### DETAILED DESCRIPTION

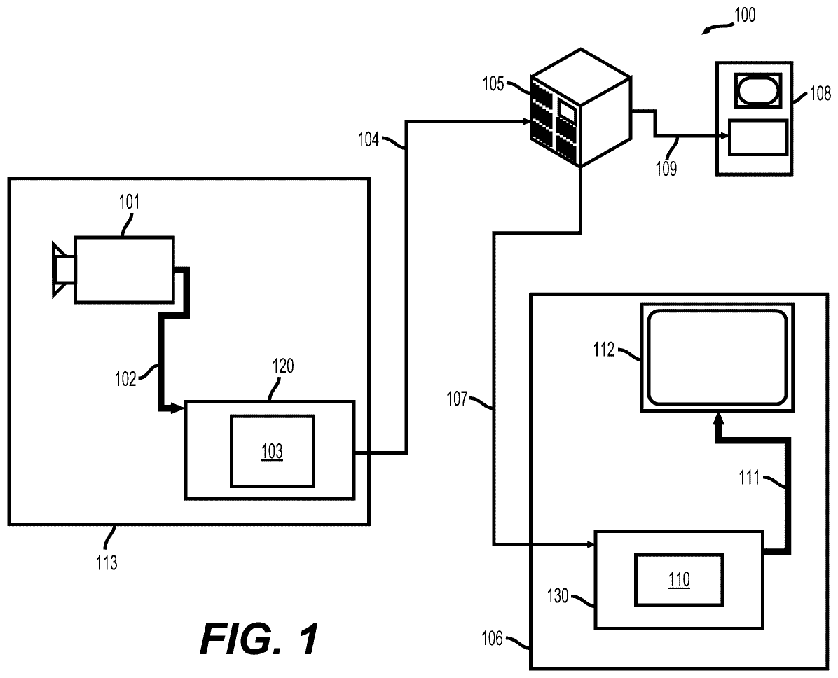

FIG. 1 shows a block diagram of a video processing system (100) in some examples. The video processing system (100) is an example of an application for the disclosed subject matter, a video encoder and a video decoder in a streaming environment. The disclosed subject matter can be equally applicable to other video enabled applications, including, for example, video conferencing, digital TV, streaming services, storing of compressed video on digital media including CD, DVD, memory stick and the like, and so on.

The video processing system (100) includes a capture subsystem (113), that can include a video source (101), for example a digital camera, creating for example a stream of video pictures (102) that are uncompressed. In an example, the stream of video pictures (102) includes samples that are taken by the digital camera. The stream of video pictures (102), depicted as a bold line to emphasize a high data volume when compared to encoded video data (104) (or coded video bitstreams), can be processed by an electronic device (120) that includes a video encoder (103) coupled to the video source (101). The video encoder (103) can include hardware, software, or a combination thereof to enable or implement aspects of the disclosed subject matter as described in more detail below. The encoded video data (104) (or encoded video bitstream), depicted as a thin line to emphasize the lower data volume when compared to the stream of video pictures (102), can be stored on a streaming server (105) for future use. One or more streaming client subsystems, such as client subsystems (106) and (108) in FIG. 1 can access the streaming server (105) to retrieve copies (107) and (109) of the encoded video data (104). A client subsystem (106) can include a video decoder (110), for example, in an electronic device (130). The video decoder (110) decodes the incoming copy (107) of the encoded video data and creates an outgoing stream of video pictures (111) that can be rendered on a display (112) (e.g., display screen) or other rendering device (not depicted). In some streaming systems, the encoded video data (104), (107), and (109) (e.g., video bitstreams) can be encoded according to certain video coding/compression standards. Examples of those standards include ITU-T Recommendation H.265. In an example, a video coding standard under development is informally known as Versatile Video Coding (VVC). The disclosed subject matter may be used in the context of VVC.

It is noted that the electronic devices (120) and (130) can include other components (not shown). For example, the electronic device (120) can include a video decoder (not shown) and the electronic device (130) can include a video encoder (not shown) as well.

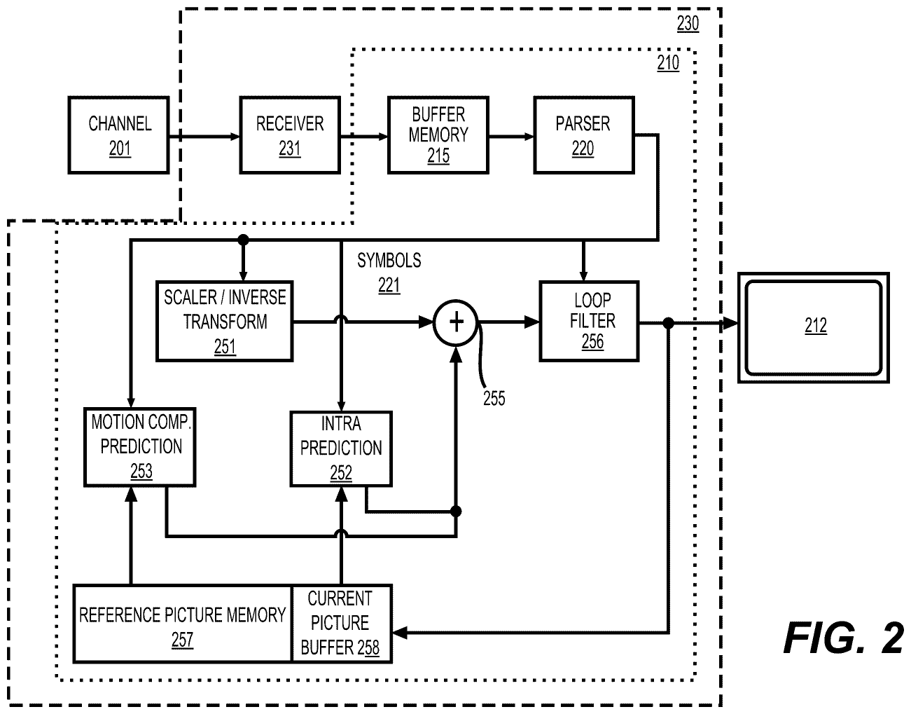

FIG. 2 shows an example of a block diagram of a video decoder (210). The video decoder (210) can be included in an electronic device (230). The electronic device (230) can include a receiver (231) (e.g., receiving circuitry). The video decoder (210) can be used in the place of the video decoder (110) in the FIG. 1 example.

The receiver (231) may receive one or more coded video sequences, included in a bitstream for example, to be decoded by the video decoder (210). In an aspect, one coded video sequence is received at a time, where the decoding of each coded video sequence is independent from the decoding of other coded video sequences. The coded video sequence may be received from a channel (201), which may be a hardware/software link to a storage device which stores the encoded video data. The receiver (231) may receive the encoded video data with other data, for example, coded audio data and/or ancillary data streams, that may be forwarded to their respective using entities (not depicted). The receiver (231) may separate the coded video sequence from the other data. To combat network jitter, a buffer memory (215) may be coupled in between the receiver (231) and an entropy decoder/parser (220) (“parser (220)” henceforth). In certain applications, the buffer memory (215) is part of the video decoder (210). In others, it can be outside of the video decoder (210) (not depicted). In still others, there can be a buffer memory (not depicted) outside of the video decoder (210), for example to combat network jitter, and in addition another buffer memory (215) inside the video decoder (210), for example to handle playout timing. When the receiver (231) is receiving data from a store/forward device of sufficient bandwidth and controllability, or from an isosynchronous network, the buffer memory (215) may not be needed, or can be small. For use on best effort packet networks such as the Internet, the buffer memory (215) may be required, can be comparatively large and can be advantageously of adaptive size, and may at least partially be implemented in an operating system or similar elements (not depicted) outside of the video decoder (210).

The video decoder (210) may include the parser (220) to reconstruct symbols (221) from the coded video sequence. Categories of those symbols include information used to manage operation of the video decoder (210), and potentially information to control a rendering device such as a render device (212) (e.g., a display screen) that is not an integral part of the electronic device (230) but can be coupled to the electronic device (230), as shown in FIG. 2. The control information for the rendering device(s) may be in the form of Supplemental Enhancement Information (SEI) messages or Video Usability Information (VUI) parameter set fragments (not depicted). The parser (220) may parse/entropy-decode the coded video sequence that is received. The coding of the coded video sequence can be in accordance with a video coding technology or standard, and can follow various principles, including variable length coding, Huffman coding, arithmetic coding with or without context sensitivity, and so forth. The parser (220) may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser (220) may also extract from the coded video sequence information such as transform coefficients, quantizer parameter values, motion vectors, and so forth.

The parser (220) may perform an entropy decoding/parsing operation on the video sequence received from the buffer memory (215), so as to create symbols (221).

Reconstruction of the symbols (221) can involve multiple different units depending on the type of the coded video picture or parts thereof (such as: inter and intra picture, inter and intra block), and other factors. Which units are involved, and how, can be controlled by subgroup control information parsed from the coded video sequence by the parser (220). The flow of such subgroup control information between the parser (220) and the multiple units below is not depicted for clarity.

Beyond the functional blocks already mentioned, the video decoder (210) can be conceptually subdivided into a number of functional units as described below. In a practical implementation operating under commercial constraints, many of these units interact closely with each other and can, at least partly, be integrated into each other. However, for the purpose of describing the disclosed subject matter, the conceptual subdivision into the functional units below is appropriate.

A first unit is the scaler/inverse transform unit (251). The scaler/inverse transform unit (251) receives a quantized transform coefficient as well as control information, including which transform to use, block size, quantization factor, quantization scaling matrices, etc. as symbol(s) (221) from the parser (220). The scaler/inverse transform unit (251) can output blocks comprising sample values, that can be input into aggregator (255).

In some cases, the output samples of the scaler/inverse transform unit (251) can pertain to an intra coded block. The intra coded block is a block that is not using predictive information from previously reconstructed pictures, but can use predictive information from previously reconstructed parts of the current picture. Such predictive information can be provided by an intra picture prediction unit (252). In some cases, the intra picture prediction unit (252) generates a block of the same size and shape of the block under reconstruction, using surrounding already reconstructed information fetched from the current picture buffer (258). The current picture buffer (258) buffers, for example, partly reconstructed current picture and/or fully reconstructed current picture. The aggregator (255), in some cases, adds, on a per sample basis, the prediction information the intra prediction unit (252) has generated to the output sample information as provided by the scaler/inverse transform unit (251).

In other cases, the output samples of the scaler/inverse transform unit (251) can pertain to an inter coded, and potentially motion compensated, block. In such a case, a motion compensation prediction unit (253) can access reference picture memory (257) to fetch samples used for prediction. After motion compensating the fetched samples in accordance with the symbols (221) pertaining to the block, these samples can be added by the aggregator (255) to the output of the scaler/inverse transform unit (251) (in this case called the residual samples or residual signal) so as to generate output sample information. The addresses within the reference picture memory (257) from where the motion compensation prediction unit (253) fetches prediction samples can be controlled by motion vectors, available to the motion compensation prediction unit (253) in the form of symbols (221) that can have, for example X, Y, and reference picture components. Motion compensation also can include interpolation of sample values as fetched from the reference picture memory (257) when sub-sample exact motion vectors are in use, motion vector prediction mechanisms, and so forth.

The output samples of the aggregator (255) can be subject to various loop filtering techniques in the loop filter unit (256). Video compression technologies can include in-loop filter technologies that are controlled by parameters included in the coded video sequence (also referred to as coded video bitstream) and made available to the loop filter unit (256) as symbols (221) from the parser (220). Video compression can also be responsive to meta-information obtained during the decoding of previous (in decoding order) parts of the coded picture or coded video sequence, as well as responsive to previously reconstructed and loop-filtered sample values.

The output of the loop filter unit (256) can be a sample stream that can be output to the render device (212) as well as stored in the reference picture memory (257) for use in future inter-picture prediction.

Certain coded pictures, once fully reconstructed, can be used as reference pictures for future prediction. For example, once a coded picture corresponding to a current picture is fully reconstructed and the coded picture has been identified as a reference picture (by, for example, the parser (220)), the current picture buffer (258) can become a part of the reference picture memory (257), and a fresh current picture buffer can be reallocated before commencing the reconstruction of the following coded picture.

The video decoder (210) may perform decoding operations according to a predetermined video compression technology or a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile can select certain tools as the only tools available for use under that profile from all the tools available in the video compression technology or standard. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an aspect, the receiver (231) may receive additional (redundant) data with the encoded video. The additional data may be included as part of the coded video sequence(s). The additional data may be used by the video decoder (210) to properly decode the data and/or to more accurately reconstruct the original video data. Additional data can be in the form of, for example, temporal, spatial, or signal noise ratio (SNR) enhancement layers, redundant slices, redundant pictures, forward error correction codes, and so on.

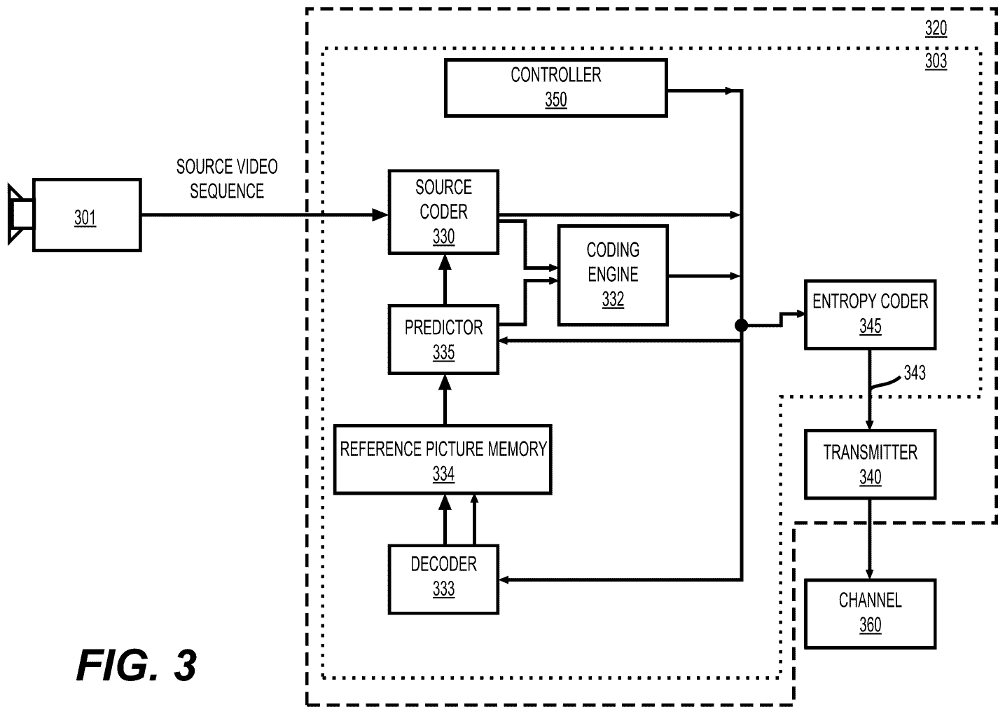

FIG. 3 shows an example of a block diagram of a video encoder (303). The video encoder (303) is included in an electronic device (320). The electronic device (320) includes a transmitter (340) (e.g., transmitting circuitry). The video encoder (303) can be used in the place of the video encoder (103) in the FIG. 1 example.

The video encoder (303) may receive video samples from a video source (301) (that is not part of the electronic device (320) in the FIG. 3 example) that may capture video image(s) to be coded by the video encoder (303). In another example, the video source (301) is a part of the electronic device (320).

The video source (301) may provide the source video sequence to be coded by the video encoder (303) in the form of a digital video sample stream that can be of any suitable bit depth (for example: 8 bit, 10 bit, 12 bit, . . . ), any colorspace (for example, BT.601 Y CrCB, RGB, . . . ), and any suitable sampling structure (for example Y CrCb 4:2:0, Y CrCb 4:4:4). In a media serving system, the video source (301) may be a storage device storing previously prepared video. In a videoconferencing system, the video source (301) may be a camera that captures local image information as a video sequence. Video data may be provided as a plurality of individual pictures that impart motion when viewed in sequence. The pictures themselves may be organized as a spatial array of pixels, wherein each pixel can comprise one or more samples depending on the sampling structure, color space, etc. in use. The description below focuses on samples.

According to an aspect, the video encoder (303) may code and compress the pictures of the source video sequence into a coded video sequence (343) in real time or under any other time constraints as required. Enforcing appropriate coding speed is one function of a controller (350). In some aspects, the controller (350) controls other functional units as described below and is functionally coupled to the other functional units. The coupling is not depicted for clarity. Parameters set by the controller (350) can include rate control related parameters (picture skip, quantizer, lambda value of rate-distortion optimization techniques, . . . ), picture size, group of pictures (GOP) layout, maximum motion vector search range, and so forth. The controller (350) can be configured to have other suitable functions that pertain to the video encoder (303) optimized for a certain system design.

In some aspects, the video encoder (303) is configured to operate in a coding loop. As an oversimplified description, in an example, the coding loop can include a source coder (330) (e.g., responsible for creating symbols, such as a symbol stream, based on an input picture to be coded, and a reference picture(s)), and a (local) decoder (333) embedded in the video encoder (303). The decoder (333) reconstructs the symbols to create the sample data in a similar manner as a (remote) decoder also would create. The reconstructed sample stream (sample data) is input to the reference picture memory (334). As the decoding of a symbol stream leads to bit-exact results independent of decoder location (local or remote), the content in the reference picture memory (334) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is used in some related arts as well.

The operation of the “local” decoder (333) can be the same as a “remote” decoder, such as the video decoder (210), which has already been described in detail above in conjunction with FIG. 2. Briefly referring also to FIG. 2, however, as symbols are available and encoding/decoding of symbols to a coded video sequence by an entropy coder (345) and the parser (220) can be lossless, the entropy decoding parts of the video decoder (210), including the buffer memory (215), and parser (220) may not be fully implemented in the local decoder (333).

In an aspect, a decoder technology except the parsing/entropy decoding that is present in a decoder is present, in an identical or a substantially identical functional form, in a corresponding encoder. Accordingly, the disclosed subject matter focuses on decoder operation. The description of encoder technologies can be abbreviated as they are the inverse of the comprehensively described decoder technologies. In certain areas a more detail description is provided below.

During operation, in some examples, the source coder (330) may perform motion compensated predictive coding, which codes an input picture predictively with reference to one or more previously coded picture from the video sequence that were designated as “reference pictures.” In this manner, the coding engine (332) codes differences between pixel blocks of an input picture and pixel blocks of reference picture(s) that may be selected as prediction reference(s) to the input picture.

The local video decoder (333) may decode coded video data of pictures that may be designated as reference pictures, based on symbols created by the source coder (330). Operations of the coding engine (332) may advantageously be lossy processes. When the coded video data may be decoded at a video decoder (not shown in FIG. 3), the reconstructed video sequence typically may be a replica of the source video sequence with some errors. The local video decoder (333) replicates decoding processes that may be performed by the video decoder on reference pictures and may cause reconstructed reference pictures to be stored in the reference picture memory (334). In this manner, the video encoder (303) may store copies of reconstructed reference pictures locally that have common content as the reconstructed reference pictures that will be obtained by a far-end video decoder (absent transmission errors).

The predictor (335) may perform prediction searches for the coding engine (332). That is, for a new picture to be coded, the predictor (335) may search the reference picture memory (334) for sample data (as candidate reference pixel blocks) or certain metadata such as reference picture motion vectors, block shapes, and so on, that may serve as an appropriate prediction reference for the new pictures. The predictor (335) may operate on a sample block-by-pixel block basis to find appropriate prediction references. In some cases, as determined by search results obtained by the predictor (335), an input picture may have prediction references drawn from multiple reference pictures stored in the reference picture memory (334).

The controller (350) may manage coding operations of the source coder (330), including, for example, setting of parameters and subgroup parameters used for encoding the video data.

Output of all aforementioned functional units may be subjected to entropy coding in the entropy coder (345). The entropy coder (345) translates the symbols as generated by the various functional units into a coded video sequence, by applying lossless compression to the symbols according to technologies such as Huffman coding, variable length coding, arithmetic coding, and so forth.

The transmitter (340) may buffer the coded video sequence(s) as created by the entropy coder (345) to prepare for transmission via a communication channel (360), which may be a hardware/software link to a storage device which would store the encoded video data. The transmitter (340) may merge coded video data from the video encoder (303) with other data to be transmitted, for example, coded audio data and/or ancillary data streams (sources not shown).

The controller (350) may manage operation of the video encoder (303). During coding, the controller (350) may assign to each coded picture a certain coded picture type, which may affect the coding techniques that may be applied to the respective picture. For example, pictures often may be assigned as one of the following picture types:

An Intra Picture (I picture) may be coded and decoded without using any other picture in the sequence as a source of prediction. Some video codecs allow for different types of intra pictures, including, for example Independent Decoder Refresh (“IDR”) Pictures.

A predictive picture (P picture) may be coded and decoded using intra prediction or inter prediction using a motion vector and reference index to predict the sample values of each block.

A bi-directionally predictive picture (B Picture) may be coded and decoded using intra prediction or inter prediction using two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (303) may perform coding operations according to a predetermined video coding technology or standard, such as ITU-T Rec. H.265. In its operation, the video encoder (303) may perform various compression operations, including predictive coding operations that exploit temporal and spatial redundancies in the input video sequence. The coded video data, therefore, may conform to a syntax specified by the video coding technology or standard being used.

In an aspect, the transmitter (340) may transmit additional data with the encoded video. The source coder (330) may include such data as part of the coded video sequence. Additional data may comprise temporal/spatial/SNR enhancement layers, other forms of redundant data such as redundant pictures and slices, SEI messages, VUI parameter set fragments, and so on.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

In some aspects, a bi-prediction technique can be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture can be coded by a first motion vector that points to a first reference block in the first reference picture, and a second motion vector that points to a second reference block in the second reference picture. The block can be predicted by a combination of the first reference block and the second reference block.

Further, a merge mode technique can be used in the inter-picture prediction to improve coding efficiency.

According to some aspects of the disclosure, predictions, such as inter-picture predictions and intra-picture predictions, are performed in the unit of blocks. For example, according to the HEVC standard, a picture in a sequence of video pictures is partitioned into coding tree units (CTU) for compression, the CTUs in a picture have the same size, such as 64×64 pixels, 32×32 pixels, or 16×16 pixels. In general, a CTU includes three coding tree blocks (CTBs), which are one luma CTB and two chroma CTBs. Each CTU can be recursively quadtree split into one or multiple coding units (CUs). For example, a CTU of 64×64 pixels can be split into one CU of 64×64 pixels, or 4 CUs of 32×32 pixels, or 16 CUs of 16×16 pixels. In an example, each CU is analyzed to determine a prediction type for the CU, such as an inter prediction type or an intra prediction type. The CU is split into one or more prediction units (PUs) depending on the temporal and/or spatial predictability. Generally, each PU includes a luma prediction block (PB), and two chroma PBs. In an aspect, a prediction operation in coding (encoding/decoding) is performed in the unit of a prediction block. Using a luma prediction block as an example of a prediction block, the prediction block includes a matrix of values (e.g., luma values) for pixels, such as 8×8 pixels, 16×16 pixels, 8×16 pixels, 16×8 pixels, and the like.

It is noted that the video encoders (103) and (303), and the video decoders (110) and (210) can be implemented using any suitable technique. In an aspect, the video encoders (103) and (303) and the video decoders (110) and (210) can be implemented using one or more integrated circuits. In another aspect, the video encoders (103) and (303), and the video decoders (110) and (210) can be implemented using one or more processors that execute software instructions.

Aspects of the disclosure include methods and systems directed to multi-model extrapolation filter-based intra prediction with clipping.

Video coding has been widely used in many applications. Various video coding standards, such as H264, H265, H266(VVC), AV1, and AVS, have been widely adopted.

A video codec may include several modules, such as intra prediction, inter prediction, transform coding, quantization, entropy coding, and in-loop filtering. Aspects of the disclosure include a set of methods for video compression, such as methods related to template matching prediction.

A current coding block and neighboring samples of the current coding block may share similar texture characteristics. Based on such a feature, neighboring reconstructed samples, called a template, may be employed to predict the current coding block. In an example, an intra prediction may be applied to predict the current coding block. The intra prediction may include angular and non-angular intra prediction modes, exploiting a directional correlation or a non-directional texture correlation between neighboring samples.

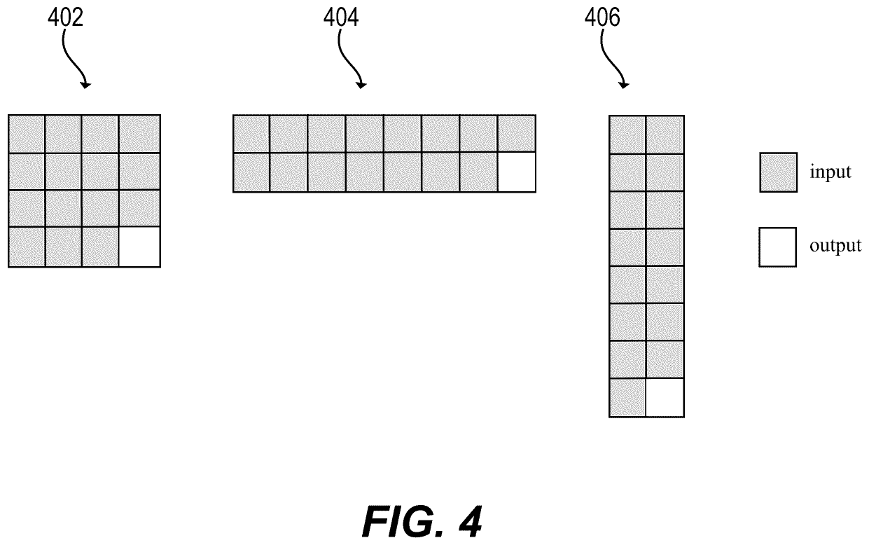

Extrapolation filter-based intra prediction can exploit correlation of neighboring samples by learning (or building) a model from neighboring samples using a filter, such as a 15-tap filter. In an example, the model includes a set of filter coefficients. The 15-tap filter may have different shapes. FIG. 4 shows three 15-tap filter shapes (402), (404), and (406).

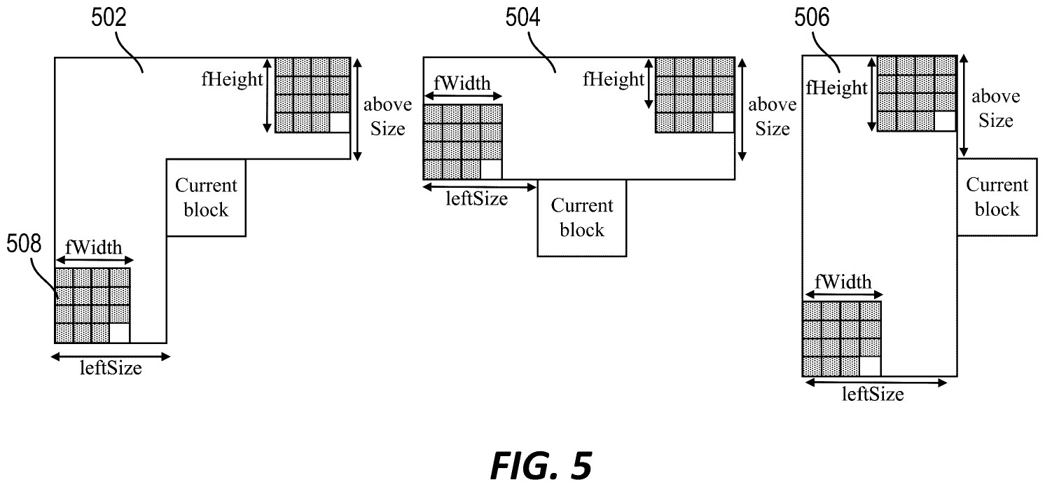

For a specific filter shape, for example, three different reference areas of reconstructed samples (also referred to as a template) can be chosen to learn the model. FIG. 5 gives an example of three example areas (or templates) (502), (504), and (506). A square filter shape (508) may be applied to loop through (or traverse) the templates to learn (or build) the model.

According to the examples shown in FIGS. 4 and 5, 9 combinations of filter shapes (e.g., (402), (404), and (406)) and template types (e.g., (502), (504), and (506)) can be applied. Given a specific filter shape and template type, coefficients of a filter may be obtained by solving a linear function from reconstructed samples in a template area. A flag may be signaled in a bitstream to indicate activation (or enablement) of an extrapolation filter-based intra prediction. When the flag is on, related syntax elements indicating a filter shape and a template type are further signaled. The selected filter (indicated by the filter shape) may loop over (or traverse) in the selected template area (indicated by the template type) with a one-pixel step to construct an auto-correlation matrix and a cross-correlation vector. From the auto-correlation matrix and the cross-correlation vector, coefficients of the filter are calculated. To generate a prediction signal of the current coding block, the filter is applied by constructing a pre-defined linear combination of the learned coefficients and reference samples.

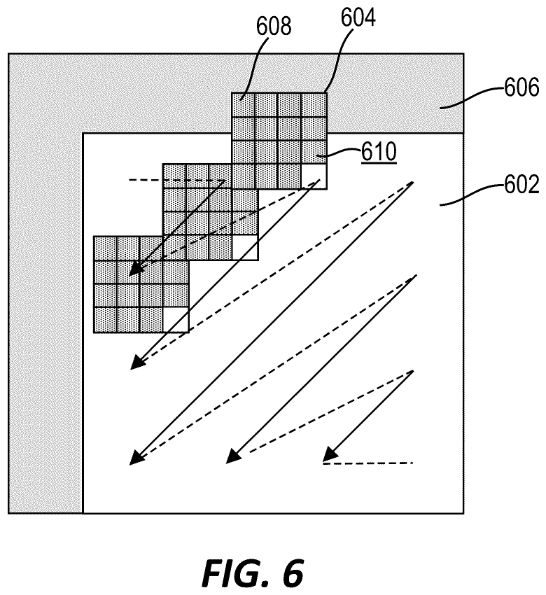

In an example, as shown in FIG. 6, when the learned model is applied, samples within a current block (602) may be generated one-by-one from a top-left position to a bottom-right position by a prediction order, such as a diagonal prediction order. When an extrapolated filter (604) is applied to a boundary of the current block (602), reconstructed samples (e.g., (608)) from a template (606) and predicted samples (e.g., (610)) from the current block (602) within the same filter shape may act as an input to the filter (604).

Based on the determined filter type and the template type, a single model of extrapolation based-filter intra prediction may generate a sub-optimal predictor, as the training data in the template may be diverse and hence the trained model is not accurate. Furthermore, the predicted signal may include some outlier samples, which cause additional distortion.

Aspects of the disclosure include application of multiple models in extrapolation filter-based intra prediction for a given filter type and template area (or template shape or template type). A threshold value may be used as a classifier to classify whether reference samples are appropriate for one (or more) of multiple models. When the learned multiple models are applied, a clipping operation may be applied on predicted samples using a minimum value and a maximum value for each model.

In an aspect, two models are learned from a given filter type and template area. In an example, the two models are represented as follows in equations (1) and (2).

$${pred}_{( x , y )} = {\sum }_{i = 0}^{13} ( {c}_{1 \_ i} \times {t}_{( x - {offsetX}_{1 \_ i} , y - {offsetY}_{1 \_ i} )} ) + {c}_{1 \_ 14} \times {2}^{bitdepth - 1} , \qquad Eq . ( 1 )$$

$$if reference \leq threshold$$

$${pred}_{( x , y )} = {\sum }_{i = 0}^{13} ( {c}_{2 \_ i} \times {t}_{( x - {offsetX}_{2 \_ i} , y - {offsetY}_{2 \_ i} )} ) + {c}_{2 \_ 14} \times {2}^{bitdepth - 1} , \qquad Eq . ( 2 )$$

$$if reference > threshold$$

Wherein the C_{1_i}, iϵ[0,14] indicates coefficients learned from a first model and C_{2_i}, iϵ[0,14] indicates coefficients learned from a second model. t_{(x-xoffset,y-yoffset)} is a reconstructed value (e.g., (608) in the template) or a predicted value (e.g., (610) in the current block) used for prediction of the current position. A comparison of a reference value to a threshold value may determine which model is trained and applied.

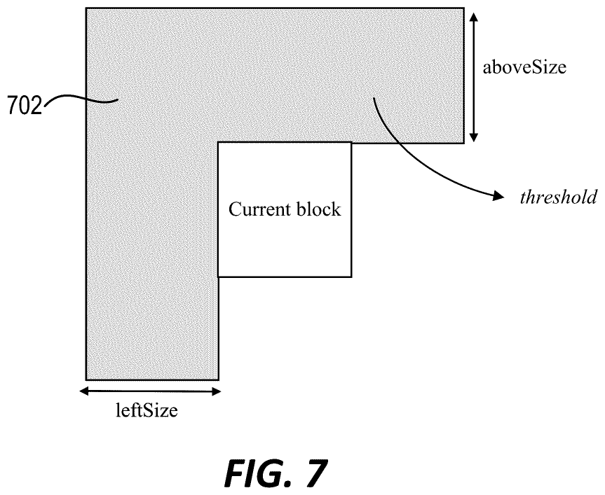

In an aspect, the threshold value may be set as an average value of samples in a reconstructed area. In an example, the average value is of all the samples in a reconstructed area, such as a L-shape reconstructed area (702) shown in FIG. 7.

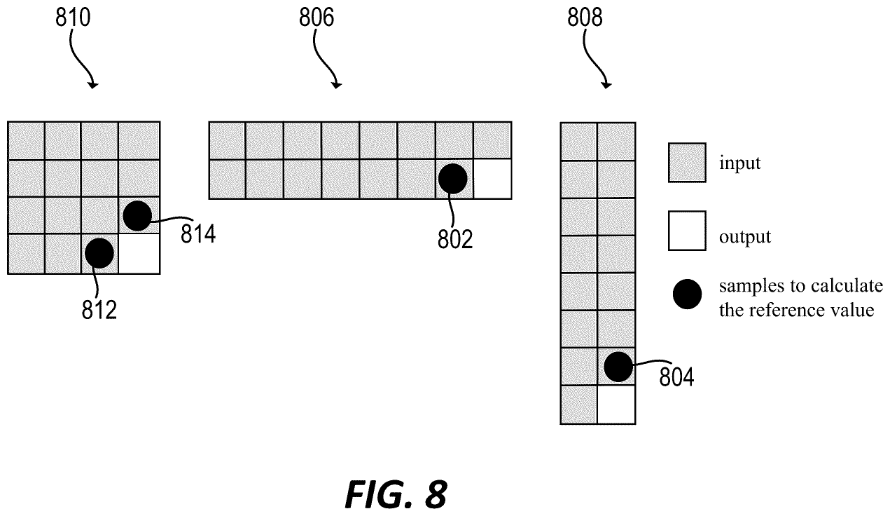

In an example, the reference value is determined based on a filter shape. For example, as shown in FIG. 8, a single sample, such as (802) or (804), may be identified in a filter shape (806) or (808), and serve as an input to calculate the reference value. In an example, the single sample may be a sample in a reconstructed area (e.g., (702)). In an aspect, for certain filter shapes, such as the filter shape (810), more than one sample, such as two samples (812) and (814), may serve as inputs to calculate the reference value, and the calculation may involve a fixed or adaptively calculated weighting of the multiple sample values.

In an aspect, for predicted sample clipping, two ranges (e.g., Min1, Max1) and (e.g., Min2, Max2) are respectively derived for the two models as proposed in equations (1) and (2).

In an example, a clipping range (e.g., Min1=0, Max1=threshold+δ) is applied for the first model shown in equation (1) when reference value<=threshold value.

In an example, a clipping range (e.g., Min1=Sₘᵢₙ, Max1=threshold+δ) is applied for the first model when reference value<=threshold value. The value Sₘᵢₙ may be signaled from bitstream.

In an example, a clipping range (e.g., Min2=threshold−δ, Max2=2^{bitdepth-1}−1) is applied for the second model shown in equation (2) when reference value>threshold value.

In an example, a clipping range (e.g., Min2=threshold−δ, Max2=Sₘₐₓ) is applied for the second model when reference value>threshold value. The value Sₘₐₓ may be signaled from bitstream.

In an example, δ is a positive value and used to control an intensity of clipping. A larger δ indicates a larger tolerance for outlier predicted samples. In an example, δ may be independently set for different models. δ may be derived or a pre-defined value.

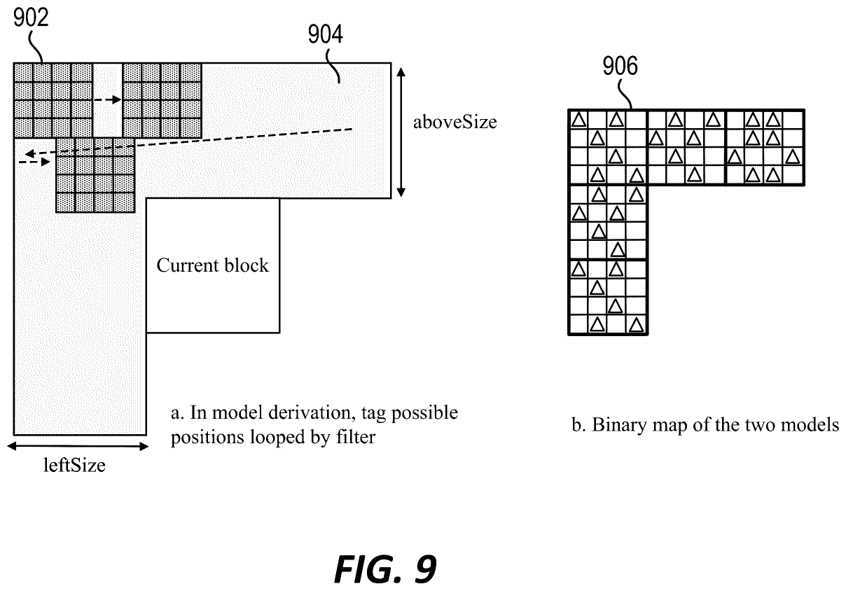

In an example, the min and max values for clipping are derived by tagging (or labelling) the reference samples that are calculated during model derivation. FIG. 9 shows an example of tagging the reference sample.

As shown in FIG. 9, when a filter (902) loops over (or traverses) a template area (904), a plurality of reference values may be determined. An example of the reference value calculation is shown in FIG. 8. Based on the reference values and positions of the reference values in the template area (904), a binary map (906) is built for different models, such as the two models shown in equations (1) and (2). In an example of the binary map (906), positions with a triangle label are identified with a first model (e.g., the model shown in equation (1)) and positions without the triangle label are identified with a second model (e.g., the model shown in equation (2)). A size of the binary map (906) may include a width of (aboveSize−3), which is a size (e.g., aboveSize) of top rows of the template area (904) reduced by a constant (e.g., 3), and a height of (leftSize−3), which is a size (e.g., leftSize) of left columns of the template area (904) reduced by the constant.

From the binary map (906), a reference value for each position may be counted (or derived based on the filter). A minimum value and a maximum value for each group (or model) are derived based on the reference values associated with the respective group (or model).

Aspects of the disclosure include methods and systems directed to intra prediction by using a multiple hypothesis model.

Video coding has been widely used in various applications, such as broadcasting, video recording, video streaming, etc. Emerging video coding standards, such as H.264, H.265/HEVC, H.266/VVC, and AV1, are published and widely adopted in the video applications. A hybrid video codec may include a plurality of coding modules, such as an intra prediction, an inter prediction, a transform coding, a quantization, an entropy coding, and a post in-loop filter.

Like a conventional bi-prediction, multi-hypothesis inter prediction mode has been proposed to support one or more additional motion-compensated prediction samples. A resulting overall prediction signal of the multi-hypothesis inter prediction mode may be obtained by sample-wise weighting. For example, based on a first additional inter prediction signal (or hypothesis) h₃ and a bi-prediction signal p_{bi}, a resulting prediction signal p₃ may be obtained as follows in equation (3):

$${p}_{3} = ( 1 - α ) {p}_{bi} + α {h}_{3} \qquad Eq . ( 3 )$$

As shown in equation (3), a weighting factor α may be derived from a lookup table by using a signaled index in a bitstream. Similar to equation (3), more than one additional prediction signals can be used. A resulting overall prediction signal can be shown in equation (4), in which each additional prediction signal is accumulated iteratively:

$${p}_{n + 1} = ( 1 - {α}_{n + 1} ) {p}_{n} + {α}_{n + 1} {h}_{n + 1} \qquad Eq . ( 4 )$$

As shown in equation (4), the resulting overall prediction signal is determined as a last prediction signal pₙ which has a largest index n.

In an aspect, a multi-hypothesis intra prediction signal may support one or more additional intra prediction samples to obtain a final resulting intra prediction signal. In an aspect, one or more syntax elements may be signaled, such as after the signaled intra prediction mode, to indicate whether the multi-hypothesis intra prediction mode is applied in addition to the signaled intra prediction mode. The one or more syntax elements may be or may include a flag. If the flag is, for example, true, the intra prediction for multi-hypothesis may be parsed or derived, and the multi-hypothesis model may be applied. Otherwise, if the flag is false, only the signaled intra prediction mode is used to generate the intra prediction sample.

In an aspect, a resulting intra prediction sample p is derived from the signaled intra prediction mode pₛ and an additional intra prediction pₕ as follows in equation (5) in which a multi-hypothesis data size is 2.

$$p = ( 1 - α ) {p}_{s} + α {p}_{h} \qquad Eq . ( 5 )$$

In an aspect, a resulting intra prediction sample is derived by iteratively accumulating each additional intra prediction signal. Equation (6) shows an example when a multi-hypothesis data size is 3:

$$p = ( 1 - {α}_{h 1} ) {p}_{0} + {α}_{h 1} {p}_{h 1} , \qquad Eq . ( 6 )$$

$$where {p}_{0} = ( 1 - {α}_{h 0} ) {p}_{s} + {α}_{h 0} {p}_{h 0}$$

As shown in equation (6), a resulting intra prediction sample p is derived from signaled intra prediction mode pₛ and two additional intra prediction pₕ₀ and pₕ₁. An overall prediction signal is iteratively accumulated by adding (or combining) each additional prediction signal and its corresponding weighting factor. In an example, the prediction samples pₕ₀ and pₕ₁ are generated based on additional intra prediction modes, such as decoder-side intra mode derivation (DIMD) or most probable mode (MPM). Because of the recursive properties of the multi-hypothesis model, the resulting intra prediction sample with a multiple-hypothesis model size of n may be derived from a general formula as follows in equation (7).

$$p = ( 1 - {α}_{h ( n - 1 )} ) {p}_{n - 2} + {α}_{h ( n - 1 )} {p}_{h ( n - 1 )} , \qquad Eq . ( 7 )$$

$$where \{ \begin{matrix}{p}_{i} = ( 1 - {α}_{hi} ) {p}_{i - 1} + {α}_{hi} {p}_{hi} , & if i ϵ [ 1 , n - 2 ] \\ {p}_{0} = ( 1 - {α}_{h 0} ) {p}_{s} + {α}_{h 0} {p}_{h 0 )} , & if i = 0\end{matrix}$$

where i is increased from 0 to n−2.

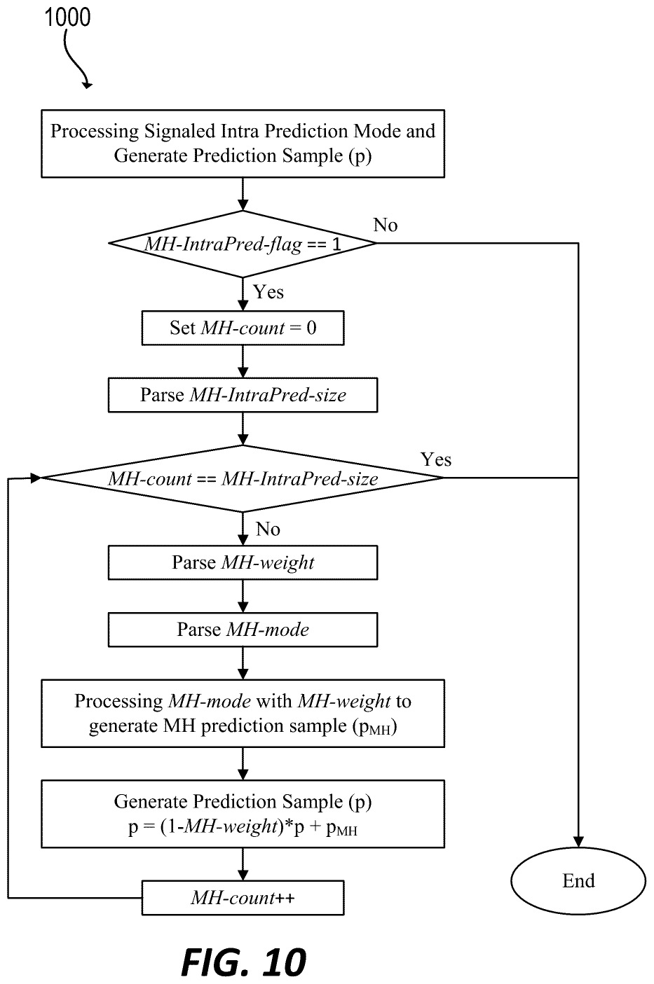

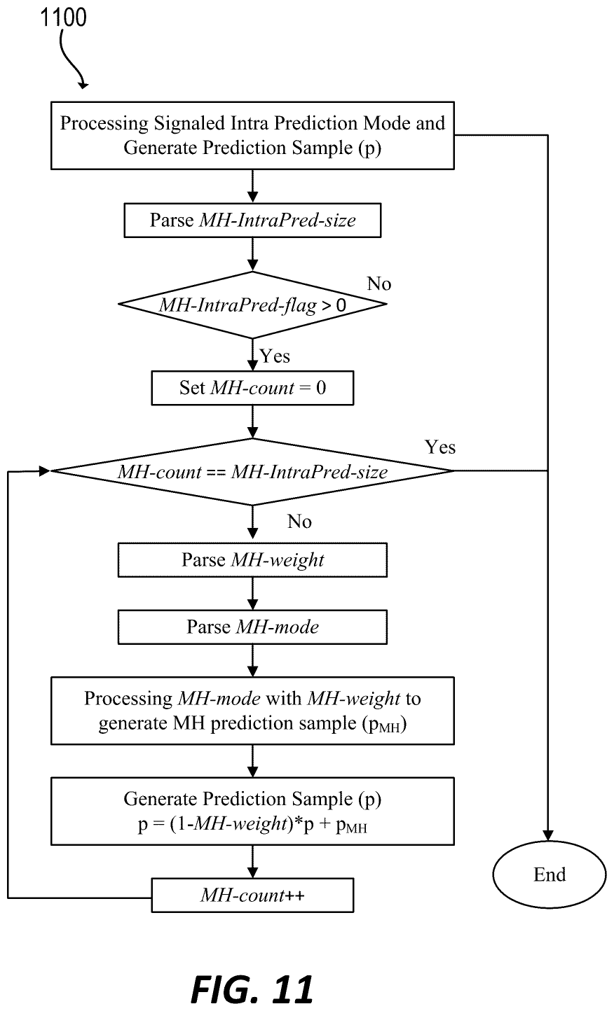

In an example, a decoding processing of multi-hypothesis intra prediction mode is shown in FIGS. 10-11. FIG. 10 shows a flow chart (1000) outlining a decoding process of multi-hypothesis intra prediction indicated by a flag. FIG. 11 shows a flow chart (1100) outlining a decoding process of multi-hypothesis intra prediction determined by a multi-hypothesis data size. As shown in FIGS. 10 and 11, a weighting factor (e.g., MH-weight) for each additional intra prediction mode is derived based on a lookup table and indicated by a signaled index. A resulting intra prediction sample is iteratively accumulated for each additional intra prediction signaled in the bitstream.

In an aspect, intra prediction modes (e.g., pₕ₀ and pₕ₁) for the multi-hypothesis prediction are derived from neighboring coded blocks (e.g., based on DIMD or MPM).

In an aspect, intra prediction mode candidates are constructed from the intra prediction modes of neighboring codded blocks.

In an aspect, the weighting factor for each additional prediction sample is a predefined fixed weighting value or a signaled/derived value. The derived value may be indicated, for example, by an index and the index may be signaled in the bitstream.

In an aspect, flags indicating the multi-hypothesis intra prediction mode and the multi-hypothesis data size are signaled in the bitstream at each coding block level.

In an aspect, the flag of multi-hypothesis intra prediction mode is signaled when a signaled intra prediction mode satisfies at least one condition. For example, the intra prediction mode includes a non-conventional intra prediction mode, a non-directional intra prediction mode, a non-planar mode, and/or a non-DC mode. Otherwise, the flag of multi-hypothesis intra prediction mode may not be signaled and may be implicitly assigned as false.

In an aspect, when the multi-hypothesis intra prediction mode is selected from plural candidates, an index may be signaled to indicate which candidate is used for the multi-hypothesis intra prediction.

In an aspect, the additional intra prediction mode in the multi-hypothesis prediction is explicitly signaled in the bitstream to indicate which intra prediction mode is selected.

In an aspect, the additional intra prediction mode in the multi-hypothesis is restricted as one of pre-defined (or allowed) intra prediction modes. The allowed intra prediction modes may be based on a block width and/or a block height and/or block size information. An index is signaled in the bitstream to indicate which allowed intra prediction mode is selected from the predefined set.

In an aspect, the additional intra prediction mode in the multi-hypothesis is implicitly assigned to a default intra prediction mode. The default intra prediction mode may include, but is not limited to, a planar mode, a DC mode, etc.

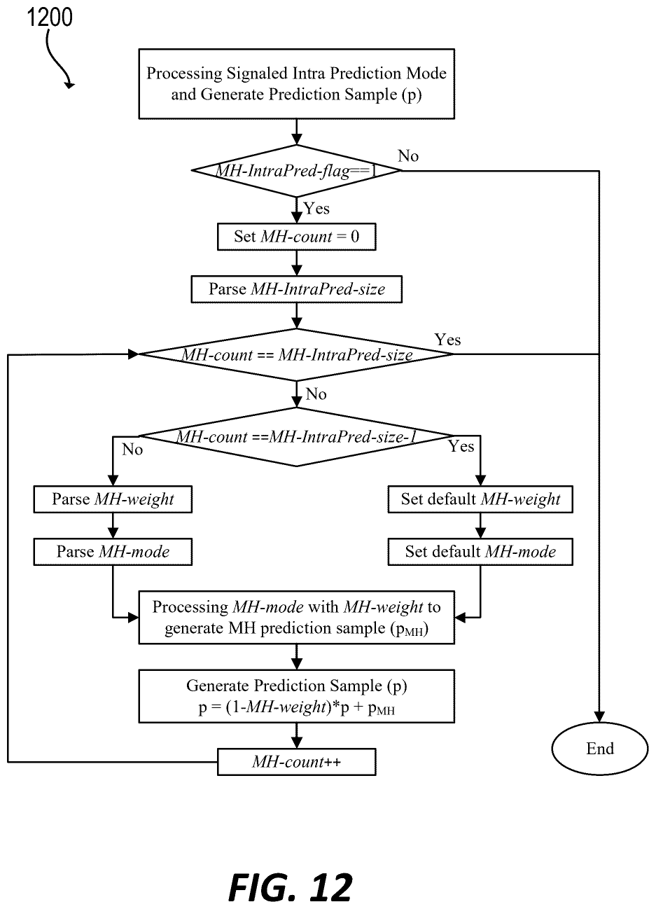

In an aspect, the last additional intra prediction is implicitly assigned to a default mode. A second additional intra prediction mode is implicitly assigned to a default mode without any signaling when the multi-hypothesis data size is 2. FIG. 12 shows an example of a decoding flow chart (1200) for the multi-hypothesis intra prediction mode, in which a last additional intra prediction mode in the multi-hypothesis intra prediction mode is assigned implicitly. As shown in FIG. 12, a predefined weight (e.g., MH-weight) is also used as the weighting factor of the implicit default mode assignment (or the implicitly assigned default mode).

In an aspect, a default intra prediction mode list is constructed to determine the additional intra prediction in the multi-hypothesis intra prediction mode. The default intra prediction mode list may be constructed from a predefined list. A first available intra prediction mode in the predefined list may be constructed into the default intra prediction mode list.

In an aspect, the last additional intra prediction is implicitly assigned to a default mode. That default mode is derived from a default mode list. The default mode list is constructed in a same manner as the aforementioned default intra prediction mode list.

In an aspect, the additional intra prediction mode in the multi-hypothesis intra prediction mode is a non-directional intra prediction mode.

Aspects of the disclosure include methods and systems directed to a directional padding method for picture boundary padding.

Video coding has been widely used in various applications. Video coding standards, such as H264, H265, H266(VVC), AV1, and AVS, have been widely adopted.

A video codec may include various modules, such as intra/inter prediction, transform coding, quantization, entropy coding, in-loop filtering, etc. As one of the main modules, several intra prediction technologies have been proposed. The intra prediction technologies include both conventional signaling processing methods and, more recently, neural network-based methods.

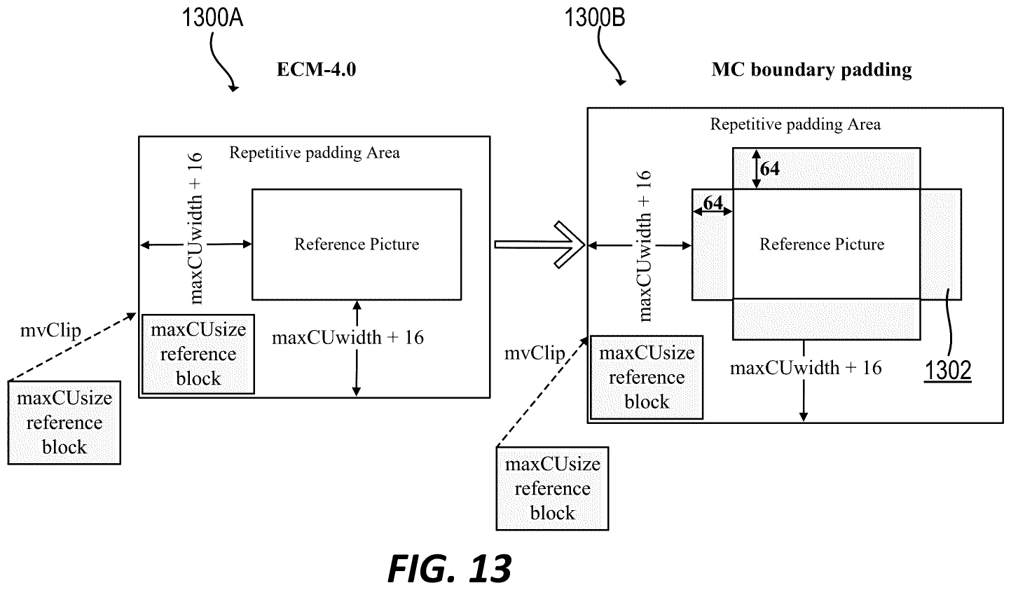

FIG. 13 shows a repetitive (or mirror) padding (1300A) and a motion compensated (MC) boundary padding (1300B). As shown in the repetitive padding (1300A), when a decoder performs motion compensation when a motion vector points to a block outside a frame boundary, repetitive padded pixels from the picture boundary may be used as reference pixels. As shown in the MC boundary padding (1300B), a motion compensated boundary pixel padding (MC Padding) may include a MC padding area (1320).

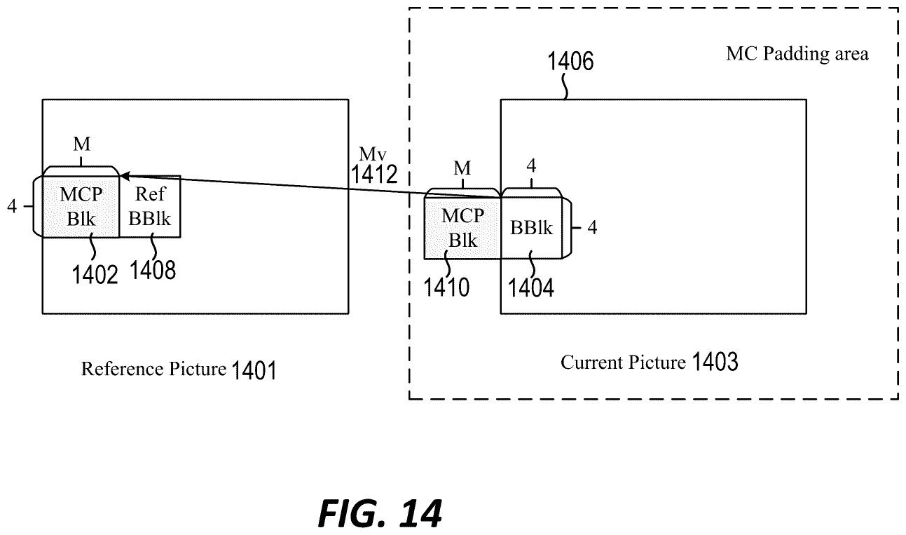

FIG. 14 shows an example of MC padding in which a M×4 padding block (1402) is derived according to a left padding direction. As shown in FIG. 14, a MCP block (1410) may be identified by a motion vector (not shown) as a reference block for a current block (not shown) in a current picture (not shown). The MCP block (1410) may be positioned along a boundary (1406) of a reference picture (1403). The reference picture (1403) may also be referred to as a current picture with respect to a reference picture (1401) in FIG. 14. The MCP block (1410) may have a size of 4×M or M×4, where M is a desired frame boundary extension. A motion vector (1412) is derived from a 4×4 block (1404) at the picture boundary (1406). If the 4×4 block (1404) at the picture boundary is intra coded, a zero motion vector is used. If the 4×4 block at the picture boundary is coded with a bi-directional inter prediction, only the motion vector, which points to the pixel farther away from the frame boundary, is used in motion compensation for padding.

In an example of FIG. 14, the MV (1412) points to a reference block (1408) in the reference picture (1401). In an example, both the reference picture (1403) and the reference picture (1401) are reference pictures of the current picture (not shown). In an example, the reference picture (1401) is reconstructed earlier than the reference picture (1403). According to the motion compensated boundary pixel padding, the MCP block (1410) may be padded (or filled) based on a MCP block (1402) that is positioned within the reference picture (1401). The MCP block (1402) is positioned within the reference picture (1401) and adjacent to the reference block (1408). In an aspect, pixels in MC padding block (1410) may be corrected with an offset, which is equal to a difference between the DC values of the reconstructed boundary 4×4 block (1404) and a corresponding 4×4 reference block (1408). Moreover, M is set at least equal to 4 when the motion vector (1412) points to a position (e.g., (1402)) within the bounds of the reference picture (1401). If M is less than 64, the rest of the padded area may be filled with the repetitive padded samples.

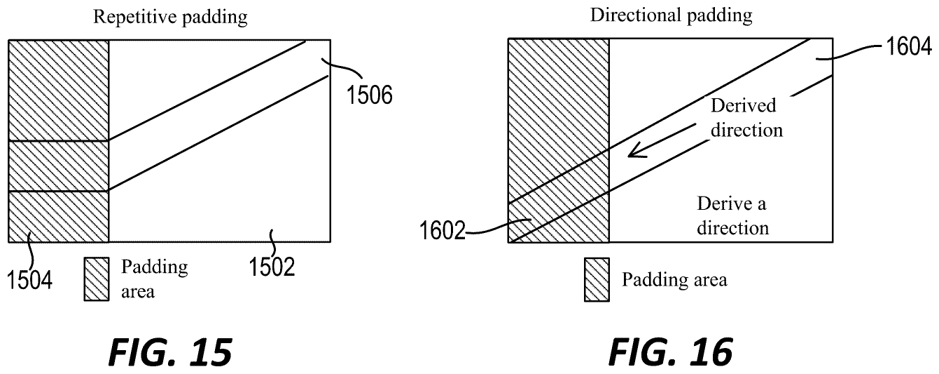

In an example, no matter whether the MC padding is applied or not, the repetitive padding is applied when the M size in FIG. 14 is smaller than a preset value, such as 64. As shown in FIG. 15, the repetitive padding method may perform padding horizontally or vertically using nearest samples, such as samples within the reference picture (1502) closest to the padding area (1504). Thus, the repetitive padding may fail to capture directional characteristics from the actual content (1506).

Aspects of the disclosure is directed to directional padding to capture the directional characteristics from the actual content.

In an aspect, when an available MC padding block (e.g., (1410)) is smaller than a maximum MC padding width or height, the directional padding is applied instead of the repetitive padding. A padding direction may be derived based on a texture of a motion compensation block (e.g. (1410)) originally for the MC padding. The padding area is then filled with samples in the derived direction. FIG. 16 illustrates an example of the proposed directional padding. As shown in FIG. 16, a padding area (1602) is filled with samples (1604) within a picture (e.g., reference picture (1403)) along a derived direction.

In an aspect, the disclosed directional padding instead of MC padding is applied when a block, such as a 4×4 block (e.g., (1404)) at the picture boundary (e.g., (1406)) is coded as an intra block.

In an aspect, when a motion vector of a current block points outside of a reference picture boundary (e.g., (1406)), the proposed directional padding is applied. When the motion vector of the current block points outside of the reference picture boundary, it may indicate that the current block is arranged across the boundary of the reconstructed region (e.g., a reconstructed region of a current picture).

In an aspect, a direction (or padding direction) is one of intra prediction modes. For example, the padding direction is a direction indicated by the one of intra prediction modes.

In an aspect, a direction (or padding direction) is derived from the motion compensated block (e.g., (1410)) originally for the MC padding.

In an aspect, the direction is derived using a gradient-based intra mode derivation method on the motion compensated block.

In an example, a gradient-based intra mode derivation is applied to the motion compensated block (e.g., (1410)). Based on a histogram of gradients, a direction is selected based on the histogram of gradients. For example, the direction is indicated by an intra prediction mode derived from the histogram of gradients. The selected direction is used for directional padding.

In an aspect, a padding area (e.g., (1602)) is padded using nearest samples (e.g., (1604)) in the derived direction.

In an example, the padding area is filled (or padded) with conventional intra prediction (e.g., angular intra prediction modes). For example, the padding area is filled with conventional interpolated reference samples according to the conventional intra prediction.

In an example, when the padding area is filled (or padded) with conventional intra prediction, position dependent prediction improvement may be applied. For example, different weights may be applied to each sample in the filled padding area according to the positions of the samples.

In an aspect, the motion compensated block (e.g., (1410)) for the MC padding is corrected with an offset.

In an example, the offset is a difference between the DC values (e.g., average value) of the reconstructed boundary block (e.g., BBlK (1404)) and a corresponding reference block (e.g., ref BBlK (1408)).

In an aspect, when the motion vector of the current block points outside of reference picture boundary (e.g., (1406)), the directional padding is applied for motion compensation.

In an example, the direction is derived using a gradient-based intra mode derivation on a partial boundary block that is within the boundary. For example, the partial boundary block is a part of the BBlK (1404) within the boundary (1406) when the BBlK (1404) crosses the boundary (1406).

In an example, a gradient-based intra mode derivation is applied to the partial reference block (e.g., (1408)). Based on the histogram of gradients, a direction is selected. The selected direction is used for directional padding.

In an example, when the reference block (e.g., (1408)) is an intra coded block, the coded intra mode is used as the direction. In an example, when the reference block is coded with an intra angular mode, such as a diagonal mode, the direction is set to diagonal.

Aspects of the disclosure include methods and systems directed to a reference shifting method for intra prediction.

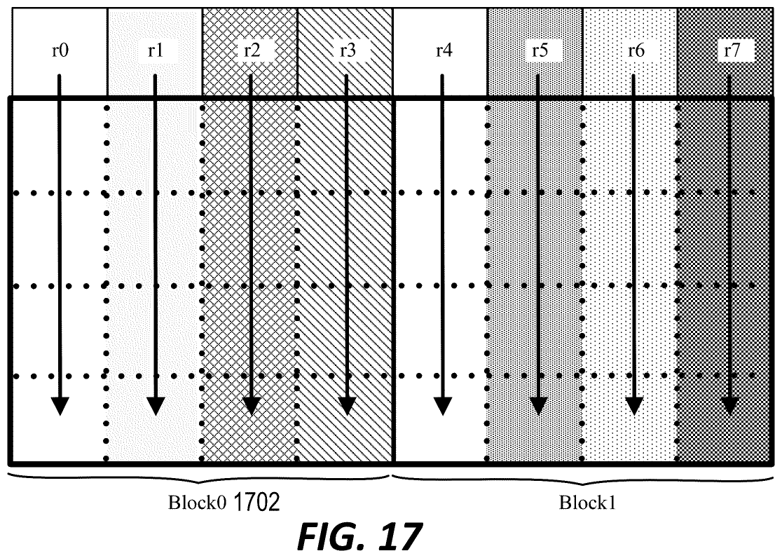

Conventional intra prediction creates a prediction block using reconstructed samples, as known as reference samples, based on the assumption that a current block is highly correlated with its neighboring samples. Various intra prediction modes, such as planar, DC, angular modes, matrix-based intra prediction, and template-based intra prediction, provide a range of options to approximate the original signal. However, limitations arise due to the block-wise encoding scheme. For example, when a minimum size of a current block is 4×4, it may not be possible to predict the current block using reference samples which are between adjacent 4×4 blocks with the same prediction mode. In an example shown in FIG. 17, Block0 (1702) may be predicted using r0, r1, r2, and r3 reference samples for vertical prediction. However, a vertical prediction signal may not be generated for Block0 (1702) using r1, r2, r3, and r4 due to the 4×4 block size constraint.

Aspects of the disclosure include methods and systems directed to a reference-shifted intra prediction method, such as a diverse intra prediction using reference samples.

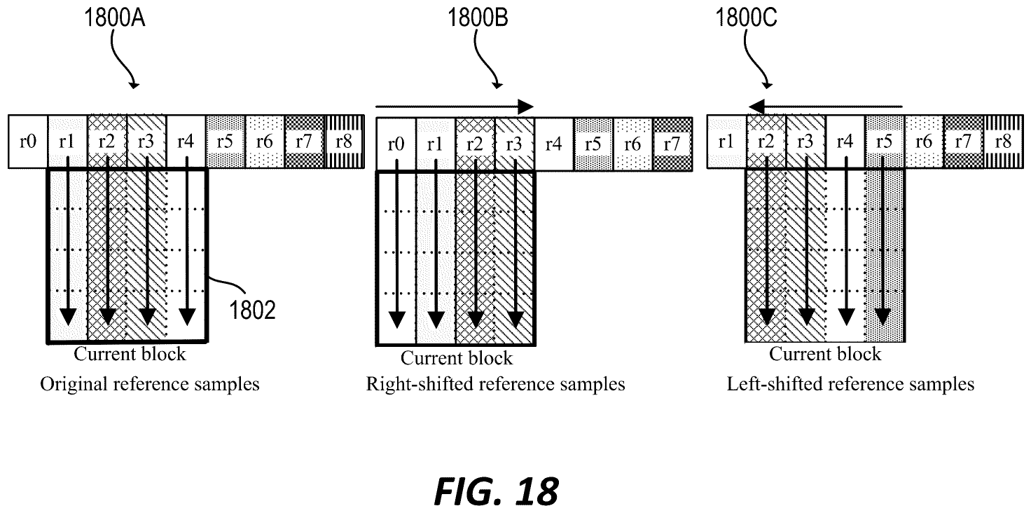

In the disclosure, reference samples used for intra prediction may be shifted to provide different prediction blocks with a same intra prediction mode. FIG. 18 shows an example of how reference samples are shifted to perform the vertical prediction. As shown in FIG. 18, a current block (1802) is predicted using shifted reference samples. As shown in FIG. 18, original positions of reference samples for the current block (1802) are shown in a configuration (1800A). The reference samples may be shifted to a right direction in a configuration (1800B) or to a left direction in a configuration (1800C). Accordingly, the current block (1802) can be predicted based on the vertical prediction using different reference samples.

In an aspect, reference sample shifting is used for one of possible intra predictions.

In an example, reference sample shifting is used for conventional intra prediction modes, such as Planar, DC, and angular prediction.

In an example, reference sample shifting is used for matrix-based intra prediction modes.

In an example, reference sample shifting is used for template-based intra prediction modes.

In an aspect, reference samples are shifted by N samples.

In an example, N is one of integers over 0, such as 1, 2, 3, . . . .

In an example, N is a fractional value, such as 0.5, 1.5, 2.5, . . . .

In an example, when N is a fractional value, reference samples are interpolated using multiple integer samples.

In an aspect, a max N (or a maximum value of N) is equal to a min CU size minus 1. For example, when the min CU size is 4, the max N is 3.

In an aspect, a max N is different for a luma component or a chroma component. In an example, when a min CU size of a luma component and a chroma component is different, a max N for each of the luma component and the chroma component also differs.

In an aspect, reference sample shifting is applied based on one or more factors, such as a block size, a block shape, or a block type.

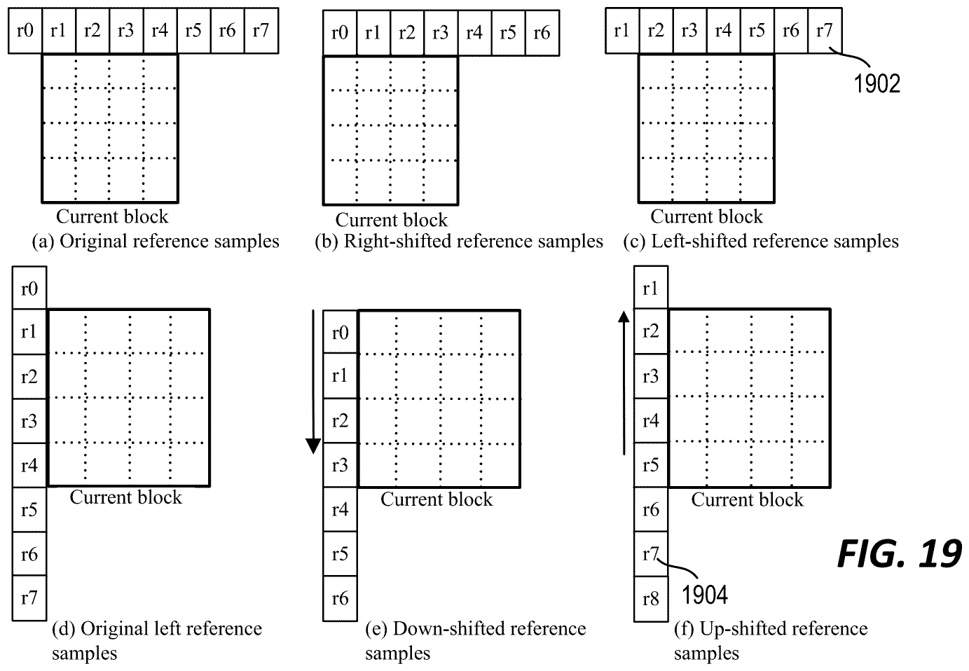

In an aspect, a shifted direction for top reference samples is either left or right, and for left reference samples, the shifted direction is either up or down. An example of the shift direction is provided in FIG. 19. As shown in FIG. 19, top reference samples (1902) are shifted in either a left direction or a right direction. Left reference samples (1904) are shifted in either a up direction or a down direction.

In an aspect, reference sample shifting is applied based on a template-based intra prediction.

In an example, all possible reference sample shifts are applied to reference samples of a template. The template may then be predicted by using shifted reference samples according to the possible reference sample shifts. By comparing a cost between a predicted template based on each possible reference sample shift and a reconstruction of the template, a decision may be made on whether to apply reference sample shifting or which one of the possible reference sample shifts is applied.

In an aspect, reference sample shifting is performed for only most probable modes.

In an example, when reference sample shifting is performed, an intra prediction mode is one of most probable modes. In such a case, a MPM flag may be inherited.

In an aspect, either a direction or a total number of shifting associated with reference sample shifting is signaled.

In an example, a syntax is signaled to indicate to which direction reference samples are shifted.

In an example, a syntax is signaled to indicate how many reference samples are shifted.

Aspects of the disclosure include methods and systems directed to intra mode derivation with signaled syntax and most probable mode adaptation.

Intra prediction explores spatial redundancy between a current block and neighboring samples of the current block. Intra prediction modes can be classified as directional and non-directional modes, indicating a directional or a non-directional correlation between neighboring reference blocks and the current block. In such cases, intra mode information may be explicitly signaled via a syntax in a bitstream. Based on the signaled intra mode, a corresponding predictor is generated based on reference samples.

Intra mode may also be derived by other ways. For example, the intra mode is implicitly derived at a decoder sider. In such cases, intra mode information may be derived from a pre-defined area of reconstructed samples. In a first method, for example, a template adjacent to a current block may be used and an intra mode may be derived based on gradients. The gradient-based intra mode derivation (or method A) may generate a Histogram of Gradients (HoG) using adjacent reconstructed samples of the current block. Based on the HoG, top N gradients are mapped to one or more conventional intra modes, and predictors based on the one or more conventional intra modes are combined as a final predictor.

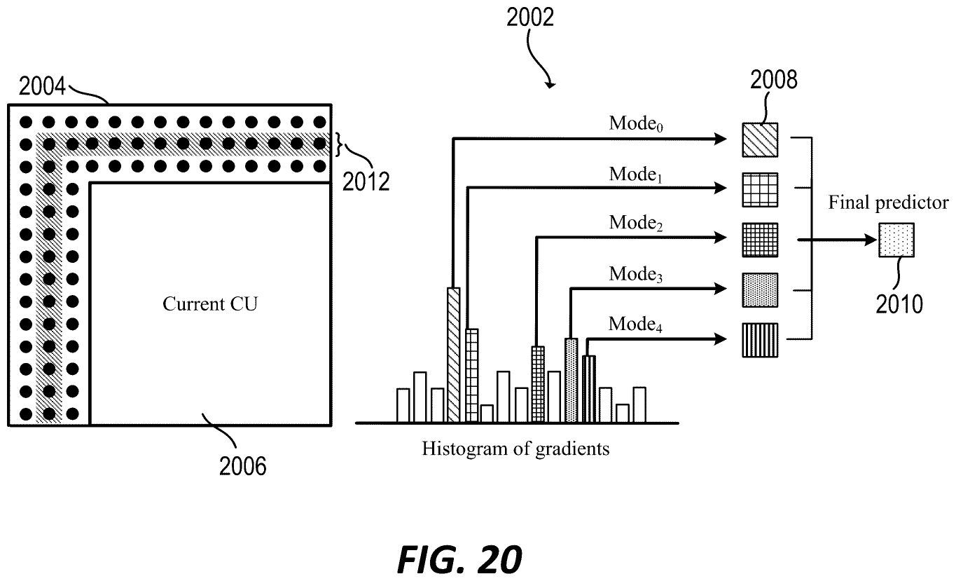

FIG. 20 shows an example of decoder-side gradient based intra mode derivation. As shown in FIG. 20, a histogram of gradients (2002) is derived based on a template (2004) of a current block (2006). A plurality of intra prediction modes (e.g., Mode0-Mode 4) can be derived by mapping a plurality of gradients with highest amplitudes in the histogram to the plurality of intra prediction modes. Each of the plurality of intra prediction modes may generate a predictor (e.g., (2008)) for the current block (2006). A final prediction (2010) may be defined as a combination of the predictors.

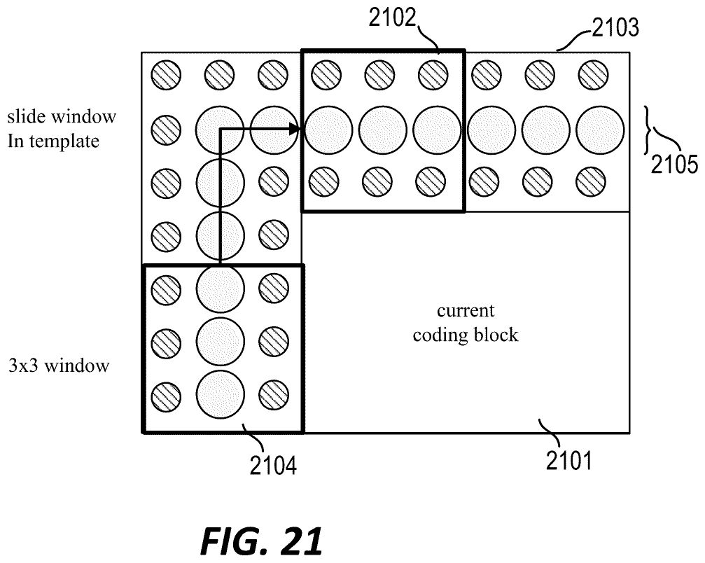

In an example, as shown in FIG. 20, the histogram of gradients may be constructed based on samples in a pre-defined region of the template (2004). In an example, the pre-defined region (2012) is a region to include samples in a center row and a center column of the template (2004). The histogram of gradients may be determined based on a texture direction of neighboring samples in the pre-defined region of the template. An example of the derivation of the histogram of gradients is provided in FIG. 21.

As shown in FIG. 21, a current coding block (2101) and a template (2103) of the current coding block (2101) are provided. A horizonal Sobel filter (2102) and a vertical Sobel filter (2104) may be applied on the samples in the pre-defined region (2105) of the template (2103). In an example, the horizontal Sobel filter and the vertical Sobel filter has a pre-defined window, such as a 3×3 window. By applying the horizontal Sobel filter and the vertical Sobel filter on the samples in the pre-defined region (2105), such as the samples in the center row and the center column in the template (2103), a horizonal gradient Gx and vertical gradient Gy are derived in each 3×3 window. A ratio of Gx and Gy for each 3×3 window within the template is calculated, which may provide intra mode information of the neighboring template. In each 3×3 window, the ratio of Gx and Gy may be mapped to a closest conventional intra prediction mode and a matched intra mode is counted in the histogram. The 3×3 window may slide (or traverse) across the template and the histogram may be updated according to the matched intra mode per each 3×3 window.

Although the method A benefits from signaling saving (as only one flag/bin is required), the fusion of the final predictor may not always result in a better predictor. Furthermore, the fusion may produce a different predictor than a single predictor derived by applying a single intra mode. The difference may reduce the potential bit saving compared to conventional Most Probable Mode (MPM) list signaling, in which a single predictor is generated by an intra mode within the MPM list.

In an aspect, first N modes derived in method A may form a Most Dominant Mode (MDM) list. Signaling of intra modes may be optimized by managing restriction between the Most Dominant Mode (MDM) list and Most Probable Mode (MPM) list. If an intra mode appears on both the MDM list and MPM list, the encoder may use a MDM syntax for signaling. The MDM syntax may have a lower bit cost because MDM is signaled before MPM. The ordering of the MDM and the MPM may reduce a signaling overhead when the intra mode that appears both in the MDM list and the MPM list is selected

In addition, an MDM may be excluded from the MPM list if the MDM is not selected via the MDM syntax. In an example, it would be redundant to include such an MDM in the MPM list because the encoder may not logically choose the MPM syntax, which has a higher bit cost to signal the same predictor. The exclusion of unselected MDMs from the MPM list may allow a more efficient use of the MPM list. Spaces may be added for other candidate modes and overall coding efficiency may be improved.

Aspects of the disclosure include a hybrid implicit mode derivation and explicit mode signaling combined with MPM restriction. In an example, up to N intra modes are derived implicitly by method A. These modes are considered as Most Dominant Modes (MDMs) and a list of MDM is built based on the MDMs. One or more syntax may be explicitly signaled to determine which MDM is applied. A final predictor is generated based on the determined MDM without fusing with other predictors. The one or more syntax may be signaled before the conventional MPM list related syntax (e.g., mpm flag, mpm index, etc). Further, as required by the restriction or constraint, MDM are ensured to be included in a same set as the intra modes in the MPM list. In an example, MPM and MDM are obtained differently. MPM may rely on the similarity of neighboring blocks. MDM may rely on texture of neighboring samples. For example, the MDM may be derived based on gradient-based intra mode derivation, which is shown in FIGS. 20-21. MPM and MDM may be same or different.

In an aspect, a same set shared by the MDM list and the MPM list are formed by intra modes corresponding to predictors that are generated by non-conventional intra prediction. The non-conventional intra prediction includes, but is not limit to, predictors produced by neural network, matrix multiplication with pre-defined coefficients in a lookup table, and other similar methods.

In an example, the shared set between MDM and MPM are intra modes numbered in following two sets: (i) mode 0, mode 1, and mode (2+2*k), k belongs to 0 to 32, inclusive (set 1); and (ii) mode 0, mode 1, and mode (2+4*k), k belongs to 0 to 16, inclusive (set 2).

In an example, when an MDM does not belong to set 1 or 2, the MDM is discarded. In an example, when an MDM does not belong to set 1 or 2, the MDM is quantized to a nearest mode in set 1 or 2. In an example, when an MPM does not belong to set 1 or 2, the MPM is discarded. In an example, when an MPM does not belong to set 1 or 2, the MPM is quantized to nearest mode in set 1 or 2.

In an aspect, the MDM list is built with sorting. The sorting is based on a cost value (e.g., sum of absolute differences (SAD) or sum of absolute transformed differences (SATD)) between reconstructed samples and predicted samples generated by an MDM within a pre-defined template area.

In an example, a syntax required to signal the MDM is a flag indicating whether MDM signaling is activated, and another syntax index indicating which intra mode (or MDM) within the MDM list is used. In an example, only the intra mode with the least cost is used and hence the index is not needed to be signaled. In an example, a size of the MDM list is a pre-defined number, such as 8.

In an aspect, prediction modes in the MDM list and the MPM list are exclusive.

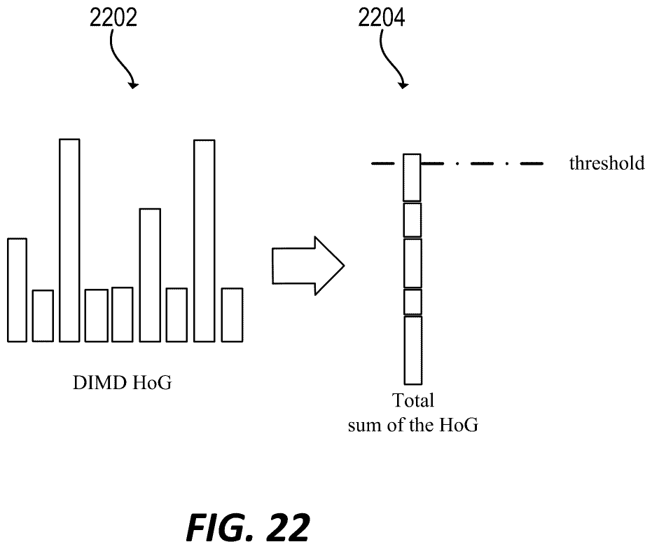

In an aspect, a threshold value is introduced in method A. The threshold value is used to terminate construction of the histogram of gradients based on a condition. For example, as shown in FIG. 22, a histogram of gradients (HoG) (2202) is under construction based on decoder-side intra mode derivation (DIMD). When an accumulated histogram of gradients (2204) is larger than and/or equal to the given threshold, the construction of the histogram of gradients is terminated.

In an aspect, up to K (K is larger than 0) modes are derived using method A. Intra modes corresponding to least S (S is larger than 0) HoG are excluded from intra mode coding. In one example, S is 16. In an example, K is 67.

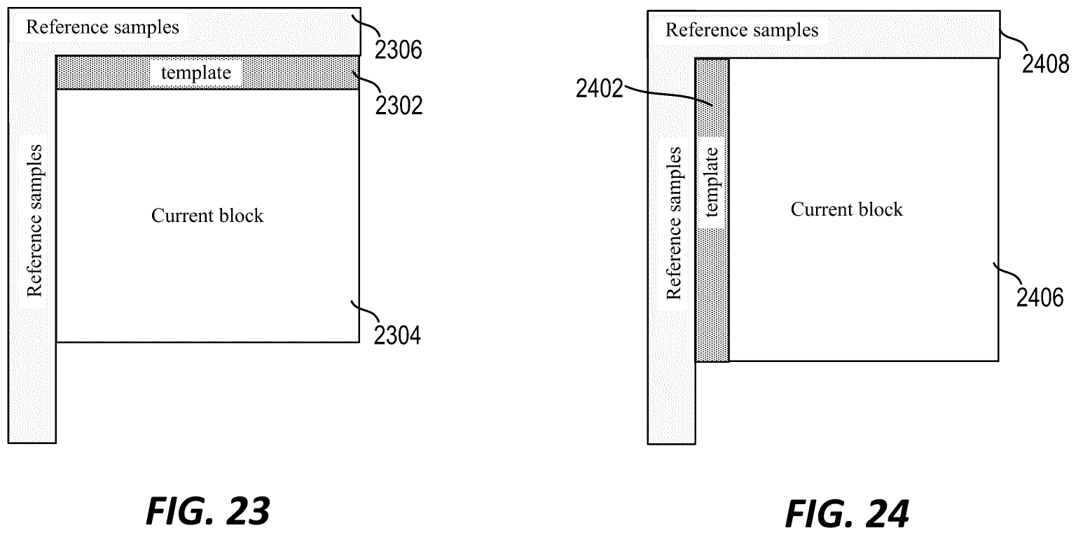

In an aspect, the MDM is derived using one of a top, a left, or both the top and the left template area in method A. In an example, when a single top template (2302) is used for a current block (2304), reference samples (2306) are shown in FIG. 23. As shown in FIG. 23, the reference samples (2306) include samples at a top side of the template (2302) and samples at a left side of the current block (2304). In an example, a set of pre-defined matrix coefficient is applied on the reference samples. The set of pre-defined matrix coefficients may multiply the reference samples to generate a prediction of the current block. A prediction mode may be derived based on the prediction of the current block. The prediction mode may be determined as an MDM in the MDM list.

In an aspect, when a single left template (2402) is used for a current block (2408), reference samples (2408) are shown in FIG. 24. A set of pre-defined matrix coefficients may further be applied to the reference samples (2408). The set of pre-defined matrix coefficients may multiply the reference samples (2408) to generate a prediction of the current block (2406). An MDM may further be derived (or indicated) based on the prediction of the current block.

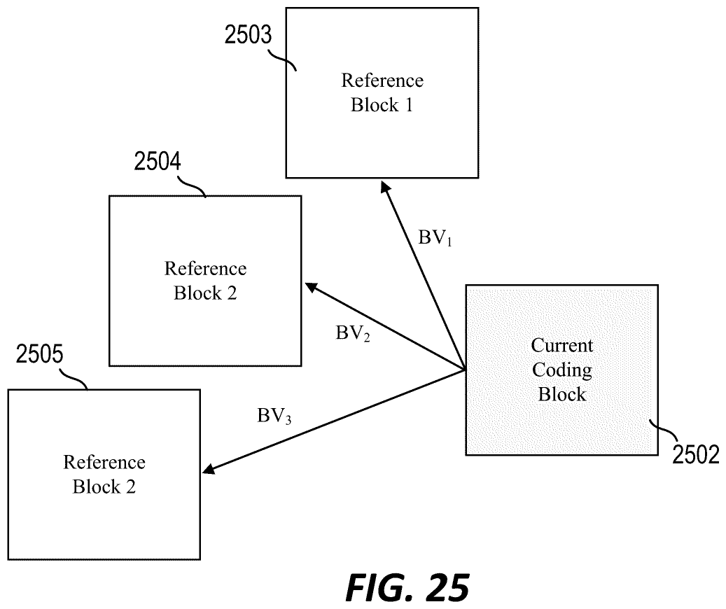

In an aspect, an MDM is derived from reference areas guided by corresponding block vectors. As shown in FIG. 25, a current coding block (2502) corresponds to a plurality of reference blocks (2503)-(2505). Each of the reference blocks may be indicated by a respective block vector (BV), such as BV₁-BV₃. In an example, a cost value between a template region of each of the reference blocks and a template region of the current block is calculated. A reference block that corresponds to a minimum cost value is selected as a prediction block of the current block. An MDM may further be derived based on the prediction block of the current block.

Aspects of the disclosure include methods and systems directed to a histogram of gradients-based directional planar.

Several decoder-side intra prediction mode derivation approaches have been proposed, such as template cost-based intra prediction mode derivation and decoder-side gradient-based intra prediction mode derivation. The gradient-based intra mode derivation may generate a histogram of gradients (HoG) using adjacent neighboring samples of a current block. Based on the histogram, top N gradients are mapped to intra modes, and predictors based on the intra modes are combined as a final predictor. An example of the decoder-side gradient-based intra prediction mode derivation is shown in FIG. 20.

Meanwhile, directional planar modes that only include horizontal interpolation or only vertical interpolation may be used to obtain predicted samples. For a planar horizontal mode, only the horizontal linear interpolation is performed based on a left reference sample and a top-right reference sample to predict a current sample. For a planar vertical mode, only the vertical linear interpolation is performed based on an above reference sample and a bottom-left reference sample to predict the current sample. A flag and an index may be signaled to indicate the directional planar mode usage and the direction, respectively.

Aspects of the disclosure include a HoG-based directional planar method. A direction (e.g., vertical or horizontal) of the planar mode (e.g., vertical planar mode or horizontal planar mode) may be determined based on HoG in a template. In addition, the HoG may be utilized to determine a transform index for the directional planar.

In an aspect, a template to derive the HoG includes spatial neighboring reconstructed samples.

In an aspect, HoG is generated from separated reconstructed samples.

In an example, HoG-left is generated from left-reconstructed samples.

In an example, HoG-above is generated from above-reconstructed samples.

In an aspect, a direction of a planar mode is not limited to a horizontal direction and a vertical direction.

In an example, the direction of the planar mode is one of intra angular modes.

In an example, the direction of the planar mode is represented as a scalar quantity ranging from 0 to 360 degrees.

In an aspect, the direction of the planar mode is determined from HoG.

In an example, the direction of the planar mode is determined by the HoG of the horizontal planar and/or the vertical planar in the template. The directional planar mode with a maximum HoG value is selected. Thus, the direction of the directional planar mode is inferred by using the HoG (or by maximum HoG value).

In an example, the HoG values of the horizontal planar and the vertical planar in the template are calculated respectively. These two HoG values are then sorted in a descending order. An index is signaled to indicate which candidate from the sorted list is selected.

In an aspect, top N gradients (e.g., top N highest amplitudes in the HoG) are used.

In an example, when a best (or selected) gradient (e.g., a gradient corresponding to a largest HoG value) is mapped to a near horizontal mode, the direction of the planar mode may be inferred as the horizontal planar mode.

In an example, when the best gradient is mapped to a near vertical mode, the direction of the planar mode may be inferred as the vertical planar mode.

In an example, when the best gradient is mapped to the near vertical mode, the direction of the planar mode may be inferred as the horizontal planar mode.

In an example, when the best gradient is mapped to the near horizontal mode, the direction of the planar mode may be inferred as the vertical planar mode.

In an example, when top N gradients are similar with the horizontal mode, the direction of the planar mode may be inferred as the horizontal planar mode.

In an aspect, HoG values may be weighted-summed to define HoG values.

In an example, HoG values of a horizontal mode and a near-horizontal mode are combined using a weighted sum according to a difference between a value of the horizontal mode and the near-horizontal mode.

In an aspect, top N gradients from separate HoGs (e.g., a vertical HoG derived based on the top template and a horizontal HoG derived based on the left template) are used.

In an example, best gradients (e.g., gradients corresponding to largest amplitudes) from each HoG are compared to determine the direction of the planar mode. When a difference between the best gradients is smaller than a threshold and close to a near horizontal mode, the direction of planar mode may be inferred as the horizontal planar mode.

In an aspect, HoG is utilized to determine a transform index for the directional planar.

In an example, best gradients (e.g., gradients corresponding to largest amplitudes) are used as the transform index.

In an example, an offset delta value is signaled on top of (or in addition to) the best gradients to indicate the offset of the inferred transform index.

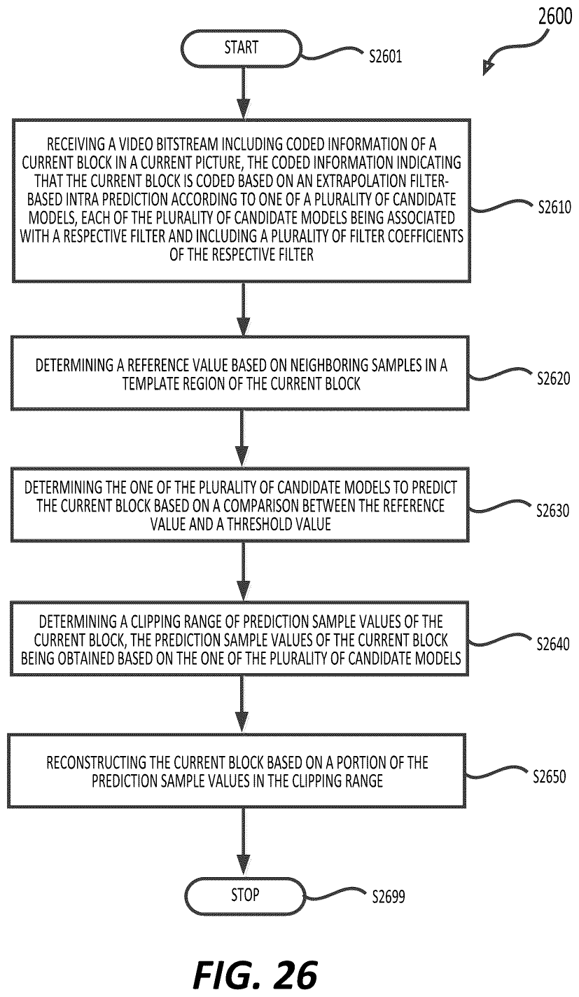

FIG. 26 shows a flow chart outlining a process (2600) according to an aspect of the disclosure. The process (2600) can be used in a video decoder. In various aspects, the process (2600) is executed by processing circuitry, such as the processing circuitry that performs functions of the video decoder (110), the processing circuitry that performs functions of the video decoder (210), and the like. In some aspects, the process (2600) is implemented in software instructions, thus when the processing circuitry executes the software instructions, the processing circuitry performs the process (2600). The process starts at (S2601) and proceeds to (S2610).

At (S2610), a video bitstream including coded information of a current block in a current picture is received. The coded information indicates that the current block is coded based on an extrapolation filter-based intra prediction according to one of a plurality of candidate models. Each of the plurality of candidate models is associated with a respective filter and includes a plurality of filter coefficients of the respective filter.

At (S2620), a reference value is determined based on neighboring samples in a template region of the current block.

At (S2630), the one of the plurality of candidate models to predict the current block is determined based on a comparison between the reference value and a threshold value.

At (S2640), a clipping range of prediction sample values of the current block is determined. The prediction sample values of the current block are obtained based on the one of the plurality of candidate models.

At (S2650), the current block is reconstructed based on a portion of the prediction sample values in the clipping range.

In an aspect, a first one of the plurality of candidate models to predict the current block is determined when the reference value is equal to or less than the threshold value. A second one of the plurality of candidate models to predict the current block is determined when the reference value is larger than the threshold value.

In an aspect, the reference value is determined as an average value of the neighboring samples in the template region of the current block.

In an aspect, based on a filter shape of a filter associated with a first one of the plurality of candidate models, one or two neighboring samples in the template region of the current block are determined. The reference value is calculated as a weighted average of the one or two neighboring samples by inputting the one or two neighboring samples into the first one of the plurality of candidate models.

In an aspect, when the reference value is equal to or less than the threshold value, a minimum value of the clipping range is determined as one of 0 and a first pre-defined value, and a maximum value of the clipping range is determined as a sum of the threshold value and a second pre-defined value. When the reference value is larger than the threshold value, the minimum value of the clipping range is determined as the threshold value minus the second pre-defined value, and the maximum value of the clipping range is determined as one of (i) a third pre-define value and (ii) 2^{bitdepth-1}−1.

In an aspect, a first filter associated with a first one of the plurality of candidate models is applied to loop through the neighboring samples in the template region to obtain a plurality of first reference values. A second filter associated with a second one of the plurality of candidate models is applied to loop through the neighboring samples in the template region to obtain a plurality of second reference values. A first clipping range associated with the first one of the plurality of candidate models is determined based on a minimum value and a maximum value of the plurality of first reference values. A second clipping range associated with the second one of the plurality of candidate models is determined based on a minimum value and a maximum value of the plurality of second reference values.

Then, the process proceeds to (S2699) and terminates.

The process (2600) can be suitably adapted. Step(s) in the process (2600) can be modified and/or omitted. Additional step(s) can be added. Any suitable order of implementation can be used.

Aspects of the disclosure include a method of video encoding. In the method, a reference value is determined based on neighboring samples in a template region of a current block in a current picture. The current block is coded based on an extrapolation filter-based intra prediction according to one of a plurality of candidate models. Each of the plurality of candidate models is associated with a respective filter and includes a plurality of filter coefficients of the respective filter. The one of the plurality of candidate models to predict the current block is determined based on a comparison between the reference value and a threshold value. A clipping range of prediction sample values of the current block is determined. The prediction sample values of the current block are obtained based on the one of the plurality of candidate models. The current block is encoded based on a portion of the prediction sample values in the clipping range.

Aspects of the disclosure include a non-transitory computer-readable medium storing a video media bitstream encoded by an encoding method. In the encoding method, a reference value is determined based on neighboring samples in a template region of a current block in a current picture. The current block is coded based on an extrapolation filter-based intra prediction according to one of a plurality of candidate models. Each of the plurality of candidate models is associated with a respective filter and includes a plurality of filter coefficients of the respective filter. The one of the plurality of candidate models to predict the current block is determined based on a comparison between the reference value and a threshold value. A clipping range of prediction sample values of the current block is determined. The prediction sample values of the current block are obtained based on the one of the plurality of candidate models. The current block is encoded based on a portion of the prediction sample values in the clipping range.

Aspects of the disclosure include a method of processing visual media data. The method includes processing a bitstream of the visual media data according to a format rule. The bitstream includes coded information of a current block in a current picture. The coded information indicates that the current block is coded based on an extrapolation filter-based intra prediction according to one of a plurality of candidate models. Each of the plurality of candidate models is associated with a respective filter and includes a plurality of filter coefficients of the respective filter. The format rule specifies that a reference value is determined based on neighboring samples in a template region of the current block. The format rule specifies that the one of the plurality of candidate models to predict the current block is determined based on a comparison between the reference value and a threshold value. The format rule specifies that a clipping range of prediction sample values of the current block is determined. The prediction sample values of the current block are obtained based on the one of the plurality of candidate models. The format rule specifies that the current block is processed based on a portion of the prediction sample values in the clipping range.

Aspects of the disclosure include a non-transitory computer-readable storage medium storing a video media bitstream which when processed by at least one processor cause the at least one processor to perform the process (2600).

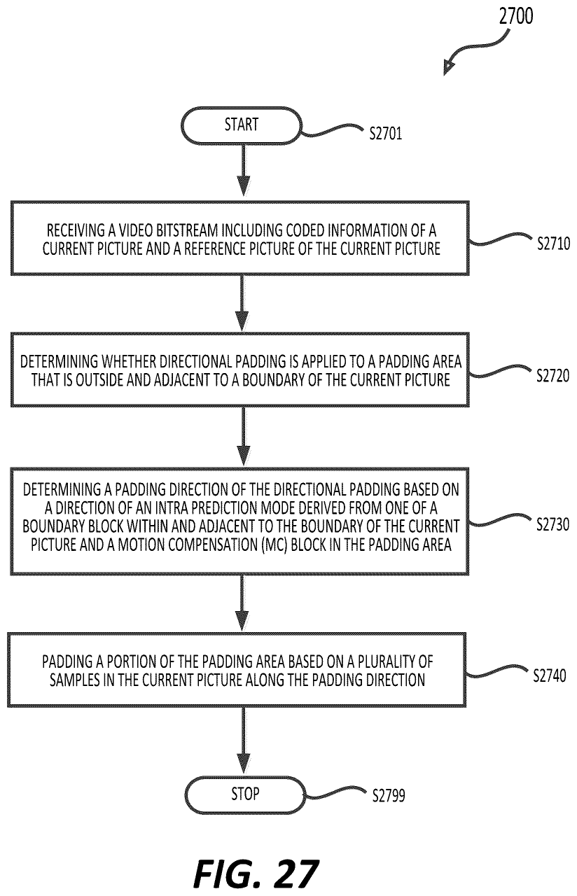

FIG. 27 shows a flow chart outlining a process (2700) according to an aspect of the disclosure. The process (2700) can be used in a video decoder. In various aspects, the process (2700) is executed by processing circuitry, such as the processing circuitry that performs functions of the video decoder (110), the processing circuitry that performs functions of the video decoder (210), and the like. In some aspects, the process (2700) is implemented in software instructions, thus when the processing circuitry executes the software instructions, the processing circuitry performs the process (2700). The process starts at (S2701) and proceeds to (S2710).

At (S2710), a video bitstream including coded information of a current picture and a reference picture of the current picture is received.

At (S2720), whether directional padding is applied to a padding area is determined. The padding area is outside and adjacent to a boundary of the current picture.

At (S2730), a padding direction of the directional padding is determined based on a direction of an intra prediction mode. The intra prediction mode is derived from one of a boundary block within and adjacent to the boundary of the current picture and a motion compensation (MC) block in the padding area.

At (S2740), a portion of the padding area is padded based on a plurality of samples in the current picture along the padding direction.

In an aspect, the directional padding is determined to be applied to the padding area of the current picture when a size of the MC block is smaller than a maximum MC width or a maximum MC height. The directional padding is determined to be applied to the padding area of the current picture when the boundary block is coded as an intra block. The directional padding is determined to be applied to the padding area of the current picture when the boundary block is arranged across the boundary of the current picture.

In an aspect, the padding direction is determined as one of an intra prediction modes that is applied to the boundary block.

In an aspect, a histogram of gradients is determined based on neighboring samples of the MC block. The intra prediction mode is determined based on the histogram of gradients. The padding direction is determined as the direction indicated by the intra prediction mode.

In an aspect, the portion of the padding area is padded using the plurality of samples in the reference picture that are nearest to the padding area along the padding direction indicated by the intra prediction mode.

In an aspect, the plurality of samples of the current picture along the padding direction are determined. The padding direction is indicated by the intra prediction mode. Respective weightings are applied to the plurality of samples to obtain weighted samples. The respective weightings to the plurality of samples are determined based on positions of the plurality of samples in the current picture. The portion of the padding area are padded based on the weighted samples.

In an aspect, samples of the MC block are further adjusted by an offset. The offset is a difference between a DC value of the boundary block in the current picture and a reference block of the boundary block in the reference picture.

In an aspect, when the boundary block is arranged across the boundary of the current picture, a histogram of gradients is determined based on neighboring samples of a part of the boundary block that is positioned within the current picture. The intra prediction mode is determined based on the histogram of gradients. The padding direction is determined as the direction indicated by the intra prediction mode.

Then, the process proceeds to (S2799) and terminates.

The process (2700) can be suitably adapted. Step(s) in the process (2700) can be modified and/or omitted. Additional step(s) can be added. Any suitable order of implementation can be used.

Aspects of the disclosure include a method of video encoding. In the method, whether directional padding is applied to a padding area is determined. The padding area is outside and adjacent to a boundary of a current picture. A padding direction of the directional padding is determined based on a direction of an intra prediction mode derived from one of a boundary block within and adjacent to the boundary of the current picture and a MC block in the padding area. A portion of the padding area is encoded by padding the portion of the padding area based on a plurality of samples in the current picture along the padding direction.

Aspects of the disclosure include a non-transitory computer-readable medium storing a video media bitstream encoded by an encoding method. In the encoding method, whether directional padding is applied to a padding area is determined. The padding area is outside and adjacent to a boundary of a current picture. A padding direction of the directional padding is determined based on a direction of an intra prediction mode derived from one of a boundary block within and adjacent to the boundary of the current picture and a MC block in the padding area. A portion of the padding area is encoded by padding the portion of the padding area based on a plurality of samples in the current picture along the padding direction.

Aspects of the disclosure include a method of processing visual media data. The method includes processing a bitstream of the visual media data according to a format rule. The bitstream includes coded information of a current picture and a reference picture of the current picture. The format rule specifies that whether directional padding is applied to a padding area that is outside and adjacent to a boundary of the current picture is determined. The format rule specifies that a padding direction of the directional padding is determined based on a direction of an intra prediction mode derived from one of a boundary block within and adjacent to the boundary of the current picture and a MC block in the padding area. The format rule specifies that a portion of the padding area is padded based on a plurality of samples in the current picture along the padding direction.

Aspects of the disclosure include a non-transitory computer-readable storage medium storing a video media bitstream which when processed by at least one processor cause the at least one processor to perform the process (2700).

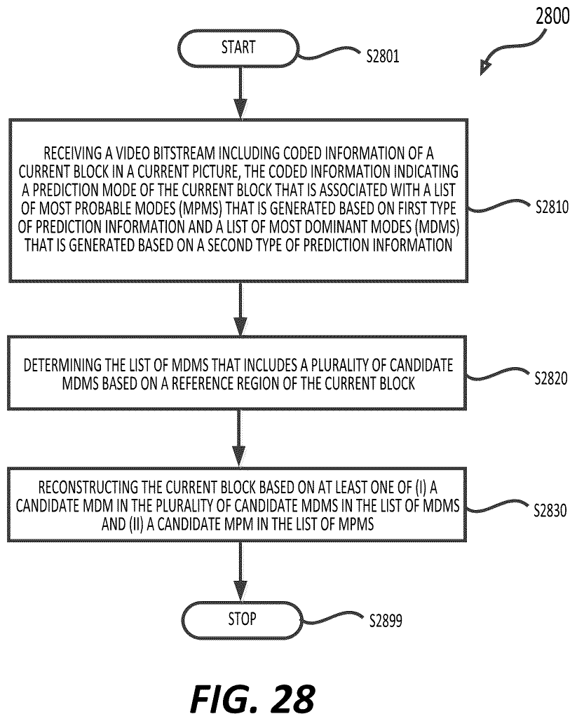

FIG. 28 shows a flow chart outlining a process (2800) according to an aspect of the disclosure. The process (2800) can be used in a video decoder. In various aspects, the process (2800) is executed by processing circuitry, such as the processing circuitry that performs functions of the video decoder (110), the processing circuitry that performs functions of the video decoder (210), and the like. In some aspects, the process (2800) is implemented in software instructions, thus when the processing circuitry executes the software instructions, the processing circuitry performs the process (2800). The process starts at (S2801) and proceeds to (S2810).

At (S2810), a video bitstream including coded information of a current block in a current picture is received. The coded information indicates a prediction mode of the current block that is associated with a list of MPMs that is generated based on first type of prediction information and a list of MDMs that is generated based on a second type of prediction information.

At (S2820), the list of MDMs that includes a plurality of candidate MDMs is determined based on a reference region of the current block.

At (S2830), the current block is reconstructed based on at least one of (i) a candidate MDM in the plurality of candidate MDMs in the list of MDMs and (ii) a candidate MPM in the list of MPMs.

In an aspect, the list of MPMs and the list of MDMs shares at least one candidate mode. The at least one candidate mode includes one of (i) non-conventional intra prediction modes, (ii) null entries; (iii) a first subset including mode 0, mode 1, and mode (2+2×k1), k1 being an integer from 0 to 32, and (iv) a second subset including mode 0, mode 1, and mode (2+4×k2), k2 being an integer from 0 to 16.

In an aspect, when one of the plurality of candidate MDMs in the list of MDMs is not included in any one of the first subset and the second subset, the one of the plurality of candidate MDMs in the list of MDMs is discarded or quantized to a nearest mode in the first subset and the second subset. When one of a plurality of candidate MPMs in the list of MPMs is not included in any one of the first subset and the second subset, the one of the plurality of candidate MPMs in the list of MPMs is discarded or quantized to a nearest mode in the first subset and the second subset.

In an aspect, a histogram of gradients associated with samples in the reference region of the current block is determined. The samples of the reference region are adjacent to the current block. The plurality of candidate MDMs of the list of MDMs is determined. The plurality of candidate MDMs corresponds to a plurality to largest amplitudes in the histogram of gradients. The plurality of largest amplitudes is larger than a pre-defined threshold value.

In an aspect, a plurality of sets of pre-defined matrix coefficients is received from the video bitstream. A plurality of sets of prediction samples of the reference region is determined. The reference region is arranged at one of a top and a left side of the current block. Each of the plurality of sets of prediction samples is determined by multiplying samples of the reference region with a respective one of the plurality of sets of pre-defined matrix coefficients. The plurality of candidate MDMs in the list of MDMs is determined based on the plurality of sets of prediction samples of the reference region.

In an aspect, a plurality of sub-reference regions of the reference region is determined according to a plurality of block vectors. Each of the plurality of sub-reference regions is indicated by a respective block vector. A cost value between a template region of each of the plurality of sub-reference regions and a template region of the current block is calculated. A subset of the plurality of sub-reference regions that corresponds to minimum cost values in the calculated cost values is determined. The one of the plurality of candidate MDMs based on the subset of the plurality of sub-reference regions.

Then, the process proceeds to (S2899) and terminates.

The process (2800) can be suitably adapted. Step(s) in the process (2800) can be modified and/or omitted. Additional step(s) can be added. Any suitable order of implementation can be used.

Aspects of the disclosure include a method of video encoding. In the method, a list of MPMs for a current block in a current picture is determined. A list of MDMs for the current block is determined. The list of MDMs includes a plurality of candidate MDMs based on a reference region of the current block. The current block is encoded into a bitstream based on at least one of (i) a candidate MDM in the plurality of candidate MDMs in the list of MDMs and (ii) a candidate MPM in the list of MPMs.

Aspects of the disclosure include a non-transitory computer-readable medium storing a video media bitstream encoded by an encoding method. In the encoding method, a list of MPMs for a current block in a current picture is determined. A list of MDMs for the current block is determined. The list of MDMs includes a plurality of candidate MDMs based on a reference region of the current block. The current block is encoded into a bitstream based on at least one of (i) a candidate MDM in the plurality of candidate MDMs in the list of MDMs and (ii) a candidate MPM in the list of MPMs.

Aspects of the disclosure include a method of processing visual media data. The method including processing a bitstream of the visual media data according to a format rule. The bitstream includes coded information of a current block in a current picture. The coded information indicates a prediction mode of the current block that is associated with a list of MPMs that is generated based on first type of prediction information and a list of MDMs that is generated based on a second type of prediction information. The format rule specifies that the list of MDMs that includes a plurality of candidate MDMs is determined based on a reference region of the current block. The format rule specifies that the current block is processed based on at least one of (i) a candidate MDM in the plurality of candidate MDMs in the list of MDMs and (ii) a candidate MPM in the list of MPMs.

Aspects of the disclosure include a non-transitory computer-readable storage medium storing a video media bitstream which when processed by at least one processor cause the at least one processor to perform the process (2800).

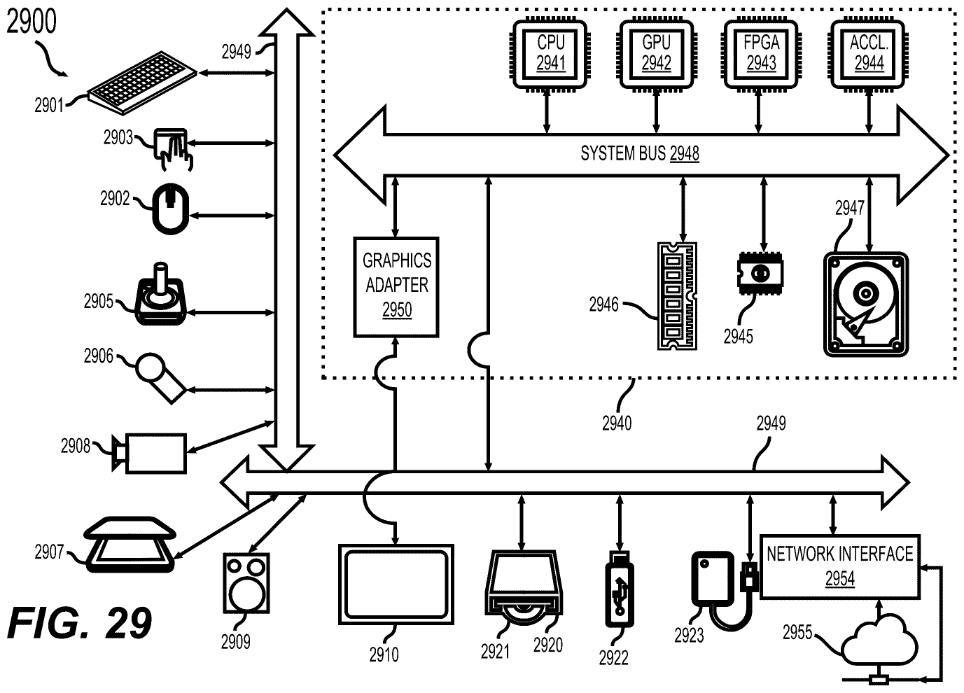

The techniques described above, can be implemented as computer software using computer-readable instructions and physically stored in one or more computer-readable media. For example, FIG. 29 shows a computer system (2900) suitable for implementing certain aspects of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 29 for computer system (2900) are examples and are not intended to suggest any limitation as to the scope of use or functionality of the computer software implementing aspects of the present disclosure. Neither should the configuration of components be interpreted as having any dependency or requirement relating to any one or combination of components illustrated in the example aspect of computer system (2900).

Computer system (2900) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (2901), mouse (2902), trackpad (2903), touch screen (2910), data-glove (not shown), joystick (2905), microphone (2906), scanner (2907), camera (2908).

Computer system (2900) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (2910), data-glove (not shown), or joystick (2905), but there can also be tactile feedback devices that do not serve as input devices), audio output devices (such as: speakers (2909), headphones (not depicted)), visual output devices (such as screens (2910) to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system (2900) can also include human accessible storage devices and their associated media such as optical media including CD/DVD ROM/RW (2920) with CD/DVD or the like media (2921), thumb-drive (2922), removable hard drive or solid state drive (2923), legacy magnetic media such as tape and floppy disc (not depicted), specialized ROM/ASIC/PLD based devices such as security dongles (not depicted), and the like.

Those skilled in the art should also understand that term “compute-readable media” as used in connection with the presently disclosed subject matter does not encompass transmission media, carrier waves, or other transitory signals.

Computer system (2900) can also include an interface (2954) to one or more communication networks (2955). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (2949) (such as, for example USB ports of the computer system (2900)); others are commonly integrated into the core of the computer system (2900) by attachment to a system bus as described below (for example Ethernet interface into a PC computer system or cellular network interface into a smartphone computer system). Using any of these networks, computer system (2900) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (2940) of the computer system (2900).

The core (2940) can include one or more Central Processing Units (CPU) (2941), Graphics Processing Units (GPU) (2942), specialized programmable processing units in the form of Field Programmable Gate Areas (FPGA) (2943), hardware accelerators for certain tasks (2944), graphics adapters (2950), and so forth. These devices, along with Read-only memory (ROM) (2945), Random-access memory (2946), internal mass storage such as internal non-user accessible hard drives, SSDs, and the like (2947), may be connected through a system bus (2948). In some computer systems, the system bus (2948) can be accessible in the form of one or more physical plugs to enable extensions by additional CPUs, GPU, and the like. The peripheral devices can be attached either directly to the core's system bus (2948), or through a peripheral bus (2949). In an example, the screen (2910) can be connected to the graphics adapter (2950). Architectures for a peripheral bus include PCI, USB, and the like.

CPUs (2941), GPUs (2942), FPGAs (2943), and accelerators (2944) can execute certain instructions that, in combination, can make up the aforementioned computer code. That computer code can be stored in ROM (2945) or RAM (2946). Transitional data can also be stored in RAM (2946), whereas permanent data can be stored for example, in the internal mass storage (2947). Fast storage and retrieve to any of the memory devices can be enabled through the use of cache memory, that can be closely associated with one or more CPU (2941), GPU (2942), mass storage (2947), ROM (2945), RAM (2946), and the like.

The computer-readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (2900), and specifically the core (2940) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (2940) that are of non-transitory nature, such as core-internal mass storage (2947) or ROM (2945). The software implementing various aspects of the present disclosure can be stored in such devices and executed by core (2940). A computer-readable medium can include one or more memory devices or chips, according to particular needs. The software can cause the core (2940) and specifically the processors therein (including CPU, GPU, FPGA, and the like) to execute particular processes or particular parts of particular processes described herein, including defining data structures stored in RAM (2946) and modifying such data structures according to the processes defined by the software. In addition or as an alternative, the computer system can provide functionality as a result of logic hardwired or otherwise embodied in a circuit (for example: accelerator (2944)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several examples of aspects, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

The above disclosure also encompasses the features noted below. The features may be combined in various manners and are not limited to the combinations noted below.

(1) A method of video decoding, the method including: receiving a video bitstream including coded information of a current block in a current picture, the coded information indicating that the current block is coded based on an extrapolation filter-based intra prediction according to one of a plurality of candidate models, each of the plurality of candidate models being associated with a respective filter and including a plurality of filter coefficients of the respective filter; determining a reference value based on neighboring samples in a template region of the current block; determining the one of the plurality of candidate models to predict the current block based on a comparison between the reference value and a threshold value; determining a clipping range of prediction sample values of the current block, the prediction sample values of the current block being obtained based on the one of the plurality of candidate models; and reconstructing the current block based on a portion of the prediction sample values in the clipping range.

(2) The method of feature (1), in which the determining the one of the plurality of candidate models further includes: determining a first one of the plurality of candidate models to predict the current block when the reference value is equal to or less than the threshold value; and determining a second one of the plurality of candidate models to predict the current block when the reference value is larger than the threshold value.

(3) The method of feature (1) or (2), in which the determining the reference value includes: determining the reference value as an average value of the neighboring samples in the template region of the current block.

(4) The method of any one of features (1) to (3), in which the determining the reference value includes: based on a filter shape of a filter associated with a first one of the plurality of candidate models, determining one or two neighboring samples in the template region of the current block; and calculating the reference value as a weighted average of the one or two neighboring samples by inputting the one or two neighboring samples into the first one of the plurality of candidate models.

(5) The method of any one of features (1) to (4), in which the determining the clipping range of the prediction sample values further includes: when the reference value is equal to or less than the threshold value, determining a minimum value of the clipping range as one of 0 and a first pre-defined value, and a maximum value of the clipping range as a sum of the threshold value and a second pre-defined value; and when the reference value is larger than the threshold value, determining the minimum value of the clipping range as the threshold value minus the second pre-defined value, and the maximum value of the clipping range as one of (i) a third pre-define value and (ii) 2^{bitdepth-1}−1.

(6) The method of any one of features (1) to (5), in which the determining the clipping range of the prediction sample values further includes: applying a first filter associated with a first one of the plurality of candidate models to loop through the neighboring samples in the template region to obtain a plurality of first reference values; applying a second filter associated with a second one of the plurality of candidate models to loop through the neighboring samples in the template region to obtain a plurality of second reference values; determining a first clipping range associated with the first one of the plurality of candidate models based on a minimum value and a maximum value of the plurality of first reference values; and determining a second clipping range associated with the second one of the plurality of candidate models based on a minimum value and a maximum value of the plurality of second reference values.

(7) A method of video decoding, the method includes: receiving a video bitstream including coded information of a current picture and a reference picture of the current picture; determining whether directional padding is applied to a padding area that is outside and adjacent to a boundary of the current picture; determining a padding direction of the directional padding based on a direction of an intra prediction mode derived from one of a boundary block within and adjacent to the boundary of the current picture and a motion compensation (MC) block in the padding area; and padding a portion of the padding area based on a plurality of samples in the current picture along the padding direction.

(8) The method of feature (7), in which the determining whether the directional padding is applied further includes one of: determining whether the directional padding is applied to the padding area of the current picture when a size of the MC block is smaller than a maximum MC width or a maximum MC height; determining whether the directional padding is applied to the padding area of the current picture when the boundary block is coded as an intra block; and determining whether the directional padding is applied to the padding area of the current picture when the boundary block is arranged across the boundary of the current picture.

(9) The method of feature (7) or (8), in which the determining the padding direction of the directional padding further includes: determining the padding direction as a direction of an intra prediction modes that is applied to the boundary block.

(10) The method of any one of features (7) to (9), in which the determining the padding direction of the directional padding further includes: determining a histogram of gradients based on neighboring samples of the MC block; determining the intra prediction mode based on the histogram of gradients; and determining the padding direction as the direction indicated by the intra prediction mode.

(11) The method of any one of features (7) to (10), in which the padding further includes: padding the portion of the padding area using the plurality of samples in the reference picture that are nearest to the padding area along the padding direction indicated by the intra prediction mode.

(12) The method of any one of features (7) to (11), in which the padding further includes: determining the plurality of samples of the current picture along the padding direction that is indicated by the intra prediction mode; applying respective weightings to the plurality of samples to obtain weighted samples, the respective weightings to the plurality of samples being determined based on positions of the plurality of samples in the current picture; and padding the portion of the padding area based on the weighted samples.

(13) The method of any one of features (7) to (12), in which samples of the MC block are further adjusted by an offset, the offset being a difference between a DC value of the boundary block in the current picture and a reference block of the boundary block in the reference picture.

(14) The method of any one of features (7) to (13), in which: when the boundary block is arranged across the boundary of the current picture, the determining the padding direction of the directional padding further includes: determining a histogram of gradients based on neighboring samples of a part of the boundary block that is positioned within the current picture; determining the intra prediction mode based on the histogram of gradients; and determining the padding direction as the direction indicated by the intra prediction mode.

(15) A method of video decoding, the method including: receiving a video bitstream including coded information of a current block in a current picture, the coded information indicating a prediction mode of the current block that is associated with a list of most probable modes (MPMs) that is generated based on first type of prediction information and a list of most dominant modes (MDMs) that is generated based on a second type of prediction information; determining the list of MDMs that includes a plurality of candidate MDMs based on a reference region of the current block; and reconstructing the current block based on at least one of (i) a candidate MDM in the plurality of candidate MDMs in the list of MDMs and (ii) a candidate MPM in the list of MPMs.

(16) The method of feature (15), in which: the list of MPMs and the list of MDMs shares at least one candidate mode, and the at least one candidate mode includes one of (i) non-conventional intra prediction modes, (ii) null entries; (iii) a first subset including mode 0, mode 1, and mode (2+2×k1), k1 being an integer from 0 to 32, and (iv) a second subset including mode 0, mode 1, and mode (2+4×k2), k2 being an integer from 0 to 16.

(17) The method of feature (15) or (16), in which: when one of the plurality of candidate MDMs in the list of MDMs is not included in any one of the first subset and the second subset, the one of the plurality of candidate MDMs in the list of MDMs is discarded or quantized to a nearest mode in the first subset and the second subset, and when one of a plurality of candidate MPMs in the list of MPMs is not included in any one of the first subset and the second subset, the one of the plurality of candidate MPMs in the list of MPMs is discarded or quantized to a nearest mode in the first subset and the second subset.

(18) The method of any one of features (15) to (17), in which the determining the list of MDMs further includes: determining a histogram of gradients associated with samples in the reference region of the current block, the samples of the reference region being adjacent to the current block; and determining the plurality of candidate MDMs of the list of MDMs that corresponds to a plurality to largest amplitudes in the histogram of gradients, the plurality of largest amplitudes being larger than a pre-defined threshold value.

(19) The method of any one of features (15) to (18), in which the determining the list of MDMs further includes: receiving a plurality of sets of pre-defined matrix coefficients from the video bitstream; determining a plurality of sets of prediction samples of the reference region, the reference region being arranged at one of a top and a left side of the current block, each of the plurality of sets of prediction samples being determined by multiplying samples of the reference region with a respective one of the plurality of sets of pre-defined matrix coefficients; and determining the plurality of candidate MDMs in the list of MDMs based on the plurality of sets of prediction samples of the reference region.

(20) The method of any one of features (15) to (19), in which the determining the list of MDMs further includes: determining a plurality of sub-reference regions of the reference region according to a plurality of block vectors, each of the plurality of sub-reference regions being indicated by a respective block vector; calculating a cost value between a template region of each of the plurality of sub-reference regions and a template region of the current block; determining a subset of the plurality of sub-reference regions that corresponds to minimum cost values in the calculated cost values; and deriving one of the plurality of candidate MDMs based on the subset of the plurality of sub-reference regions.

(21) An apparatus for video decoding, including processing circuitry that is configured to perform the method of any of features (1) to (6).

(22) An apparatus for video decoding, including processing circuitry that is configured to perform the method of any of features (7) to (14).

(23) An apparatus for video decoding, including processing circuitry that is configured to perform the method of any of features (15) to (20).

(24) A non-transitory computer-readable storage medium storing instructions which when executed by at least one processor cause the at least one processor to perform the method of any of features (1) to (20).

(25) A non-transitory computer-readable storage medium storing a video media bitstream which when processed by at least one processor cause the at least one processor to perform the method of any of features (1) to (20).

What is claimed is:

1. A method of video decoding, the method comprising:
receiving a video bitstream including coded information of a current block in a current picture, the coded information indicating that the current block is coded based on an extrapolation filter-based intra prediction according to one of a plurality of candidate models, each of the plurality of candidate models being associated with a respective filter and including a plurality of filter coefficients of the respective filter;
determining a reference value based on neighboring samples in a template region of the current block;
determining the one of the plurality of candidate models to predict the current block based on a comparison between the reference value and a threshold value;
determining a clipping range of prediction sample values of the current block, the prediction sample values of the current block being obtained based on the one of the plurality of candidate models; and
reconstructing the current block based on a portion of the prediction sample values in the clipping range.

2. The method of claim 1, wherein the determining the one of the plurality of candidate models further comprises:
determining a first one of the plurality of candidate models to predict the current block when the reference value is equal to or less than the threshold value; and
determining a second one of the plurality of candidate models to predict the current block when the reference value is larger than the threshold value.

3. The method of claim 1, wherein the determining the reference value comprises:
determining the reference value as an average value of the neighboring samples in the template region of the current block.

4. The method of claim 1, wherein the determining the reference value comprises:
based on a filter shape of a filter associated with a first one of the plurality of candidate models,
determining one or two neighboring samples in the template region of the current block; and
calculating the reference value as a weighted average of the one or two neighboring samples by inputting the one or two neighboring samples into the first one of the plurality of candidate models.

5. The method of claim 1, wherein the determining the clipping range of the prediction sample values further comprises:
when the reference value is equal to or less than the threshold value, determining a minimum value of the clipping range as one of 0 and a first pre-defined value, and a maximum value of the clipping range as a sum of the threshold value and a second pre-defined value; and
when the reference value is larger than the threshold value, determining the minimum value of the clipping range as the threshold value minus the second pre-defined value, and the maximum value of the clipping range as one of (i) a third pre-define value and (ii) 2^{bitdepth-1}−1.

6. The method of claim 1 wherein the determining the clipping range of the prediction sample values further comprises:
applying a first filter associated with a first one of the plurality of candidate models to loop through the neighboring samples in the template region to obtain a plurality of first reference values;
applying a second filter associated with a second one of the plurality of candidate models to loop through the neighboring samples in the template region to obtain a plurality of second reference values;
determining a first clipping range associated with the first one of the plurality of candidate models based on a minimum value and a maximum value of the plurality of first reference values; and
determining a second clipping range associated with the second one of the plurality of candidate models based on a minimum value and a maximum value of the plurality of second reference values.

7. A method of video decoding, the method comprising:
receiving a video bitstream including coded information of a current picture and a reference picture of the current picture;
determining whether directional padding is applied to a padding area that is outside and adjacent to a boundary of the current picture;
determining a padding direction of the directional padding based on a direction of an intra prediction mode derived from one of a boundary block within and adjacent to the boundary of the current picture and a motion compensation (MC) block in the padding area; and
padding a portion of the padding area based on a plurality of samples in the current picture along the padding direction.

8. The method of claim 7, wherein the determining whether the directional padding is applied further comprises one of:
determining that the directional padding is applied to the padding area of the current picture when a size of the MC block is smaller than a maximum MC width or a maximum MC height;
determining that the directional padding is applied to the padding area of the current picture when the boundary block is coded as an intra block; and
determining that the directional padding is applied to the padding area of the current picture when the boundary block is arranged across the boundary of the current picture.

9. The method of claim 7, wherein the determining the padding direction of the directional padding further comprises:
determining the padding direction as a direction of an intra prediction modes that is applied to the boundary block.

10. The method of claim 7, wherein the determining the padding direction of the directional padding further comprises:
determining a histogram of gradients based on neighboring samples of the MC block;
determining the intra prediction mode based on the histogram of gradients; and
determining the padding direction as the direction indicated by the intra prediction mode.

11. The method of claim 7, wherein the padding further comprises:
padding the portion of the padding area using the plurality of samples in the reference picture that are nearest to the padding area along the padding direction indicated by the intra prediction mode.

12. The method of claim 7, wherein the padding further comprises:
determining the plurality of samples of the current picture along the padding direction that is indicated by the intra prediction mode;
applying respective weightings to the plurality of samples to obtain weighted samples, the respective weightings to the plurality of samples being determined based on positions of the plurality of samples in the current picture; and
padding the portion of the padding area based on the weighted samples.

13. The method of claim 7, wherein samples of the MC block are further adjusted by an offset, the offset being a difference between a DC value of the boundary block in the current picture and a reference block of the boundary block in the reference picture.

14. The method of claim 7, wherein:
when the boundary block is arranged across the boundary of the current picture, the determining the padding direction of the directional padding further comprises:
determining a histogram of gradients based on neighboring samples of a part of the boundary block that is positioned within the current picture;
determining the intra prediction mode based on the histogram of gradients; and
determining the padding direction as the direction indicated by the intra prediction mode.

15. A method of video decoding, the method comprising:
receiving a video bitstream including coded information of a current block in a current picture, the coded information indicating a prediction mode of the current block that is associated with a list of most probable modes (MPMs) that is generated based on first type of prediction information and a list of most dominant modes (MDMs) that is generated based on a second type of prediction information;
determining the list of MDMs that includes a plurality of candidate MDMs based on a reference region of the current block; and
reconstructing the current block based on at least one of (i) a candidate MDM in the plurality of candidate MDMs in the list of MDMs and (ii) a candidate MPM in the list of MPMs.

16. The method of claim 15, wherein:
the list of MPMs and the list of MDMs share at least one candidate mode, and
the at least one candidate mode includes one of (i) non-conventional intra prediction modes, (ii) null entries; (iii) a first subset including mode 0, mode 1, and mode (2+2×k1), k1 being an integer from 0 to 32, and (iv) a second subset including mode 0, mode 1, and mode (2+4×k2), k2 being an integer from 0 to 16.

17. The method of claim 16, wherein:
when one of the plurality of candidate MDMs in the list of MDMs is not included in any one of the first subset and the second subset, the one of the plurality of candidate MDMs in the list of MDMs is discarded or quantized to a nearest mode in the first subset and the second subset, and
when one of a plurality of candidate MPMs in the list of MPMs is not included in any one of the first subset and the second subset, the one of the plurality of candidate MPMs in the list of MPMs is discarded or quantized to a nearest mode in the first subset and the second subset.

18. The method of claim 15, wherein the determining the list of MDMs further comprises:
determining a histogram of gradients associated with samples in the reference region of the current block, the samples of the reference region being adjacent to the current block; and
determining the plurality of candidate MDMs of the list of MDMs that corresponds to a plurality to largest amplitudes in the histogram of gradients, the plurality of largest amplitudes being larger than a pre-defined threshold value.

19. The method of claim 15, wherein the determining the list of MDMs further comprises:
receiving a plurality of sets of pre-defined matrix coefficients from the video bitstream;
determining a plurality of sets of prediction samples of the reference region, the reference region being arranged at one of a top and a left side of the current block, each of the plurality of sets of prediction samples being determined by multiplying samples of the reference region with a respective one of the plurality of sets of pre-defined matrix coefficients; and
determining the plurality of candidate MDMs in the list of MDMs based on the plurality of sets of prediction samples of the reference region.

20. The method of claim 15, wherein the determining the list of MDMs further comprises:
determining a plurality of sub-reference regions of the reference region according to a plurality of block vectors, each of the plurality of sub-reference regions being indicated by a respective block vector;
calculating a cost value between a template region of each of the plurality of sub-reference regions and a template region of the current block;
determining a subset of the plurality of sub-reference regions that corresponds to minimum cost values in the calculated cost values; and
deriving one of the plurality of candidate MDMs based on the subset of the plurality of sub-reference regions.
